(19) United States
(12) Patent Application Publication
(10) Pub. No.: US 2015/0082224 A1
(43) Pub. Date: Mar. 19, 2015

(54) COMPUTER GRAPHICAL USER INTERFACE SYSTEM, AND METHOD FOR PROJECT MAPPING

(71) Applicant: MoreStream Development LLC, Powell, OH (US)

(72) Inventors: WILLIAM M. HATHAWAY, POWELL, OH (US); LARS MAASEIDVAAG, VENICE, FL (US); CALEB HEARON, COLUMBUS, OH (US)

(21) Appl. No.: 14/487,013

(22) Filed: Sep. 15, 2014

Related U.S. Application Data
(60) Provisional application No. 61/877,826, filed on Sep. 13, 2013.

(51) Int. Cl. G06F 3/0484; G06F 3/0482; G06F 3/0481

(52) U.S. Cl. CPC G06F 3/04842; G06F 3/04817; G06F 3/0482
USPC 715/771

(57) ABSTRACT

Disclosed is a computer-implemented method of project mapping on a graphical user interface. A computer display of a computing apparatus is provided and configured to present a graphical user interface containing a plurality of graphical objects controllable by a controller (of the computing apparatus). Using at least one stored data set as input variables, a data analysis function is initiated to generate a graphical element output. A stored study object is also generated, which corresponds to the graphical element display and identified with the data analysis function and the at least one stored data set, whereby the stored study object is controller engageable to regenerate the graphical element display on the user interface.

The present application claims the benefit of U.S. Provisional Application Ser. No. 61/877,826, filed on Sep. 13, 2013 (pending), which disclosure is hereby incorporated by reference for all purposes and made a part of the present disclosure.

### FIELD

The present disclosure relates generally to a computer-human user interface for a software application, and systems and methods of implementing same. The disclosure also relates to a system, method, and computing environment for data analysis, and\or for a data analysis software application, program, or portion or module thereof. The disclosure relates further to a user interface and method that includes or incorporates object-oriented elements and/or steps, particularly in interfacing a user with a data analysis software application. Further yet, the disclosure relates to systems and methods for project activity tracking (“project mapping”) and more particularly, process tracking, thought process mapping, critical question mapping, and/or critical path mapping.

### BACKGROUND

The user interface of software and computer programs usually refers to the graphical and auditory information presented to the user on a display, and the control sequences the user employs to control the program and progress through a session. A user interface for electronic mail applications allows the user to send, receive, respond to and organize mail and related information. In simple spreadsheet applications, the user interface allows the user to enter, manipulate, and organize data. It also allows the user to create new data and/or employ mathematical tools to further analyze, organize, derive, and display data. These applications have traditionally employed menu-heavy interfaces, with which the user positions a control pointer over tabs, tiles, or texts that are descriptive of a function or data of the application. Pull-down menus and pop-up windows usually accompany selections and present different selection or task options to the user. For such straight-forward software applications, where the user only has to learn a few commands or run a few repetitive tasks to make effective use of the program, the traditional menu-heavy user interface serves its purpose. The benefit inherent in the user's familiarity with the software application and its existing user interface outweighs the efficiency and ease that may be gained from the introduction of a new and improved interface. The new interface would still have to be learned by the user, and the tasks required of the old interface may simply not be that difficult or time consuming.

On the other hand, software applications that provide data analysis and display functionalities can become difficult and cumbersome to use, especially if multiple analytical tasks are required on vast amounts of data or data types. Furthermore, some software applications provide support for larger, on-going projects that may require data analyses at different stages of projects, for different projects, and different tasks. Providing support for such projects, the software application may be required to provide an array of data analytical tools and to access and store different types of data at different times and points of a project. For example, a user engaged in a quality improvement process may benefit from data analysis at different points in a process improvement cycle. A data analytical software application such as Engine Room®, which is a proprietary application by MoreSteam.Com LLC of Ohio, supports the user by offering an array of such data analytical tools, and organizing the tools according to the stages of the process improvement effort. Such software applications must also receive and store data and data files which may be the subject of the data analysis tasks. Despite efforts to organize the data and the tools available to the user, it is not uncommon for the user to spend time not only searching for appropriate tools, but searching and selecting data to match the tools

A project process map is a project tool that may include a graphical depiction or representation of a series of ideas, thoughts, and\or decisions taken by a person or team. The series of historical activity typically pertains to a project or goal. Depending on how the individual activity or project tasks are described and presented, the map may be referenced as a critical thought process map (CTM), a critical question map (CQM), or a critical path map (CPM). As used herein, each of these and equivalent map or process mapping will be collectively referenced to as a project maps or project mapping. The common threads among these are that the individual elements identified in the map pertain to a project and that the collection of these elements represent the underlying analytical process behind the project or the problem that the project is set up to solve. The mapped activities are generally provided in a visual format that can be referenced by the person or project team throughout the duration of the project or task process. For many applications, conventional thought process mapping systems and techniques often fall short in lending practical assistance. In some situations, the maps themselves or the process of generating or maintaining the map is too difficult, complicated, or awkward. Further, because these maps are intended to represent, rather than depict, abstract processes, even the best maps or mapping techniques cannot accurately present or convey the actual activities. Accordingly, there remains a need to provide improved systems, apparatus, methods, and graphical user interfaces for thought process mapping. There is also a need for an improved user interface, and computer system for data analysis software applications, and methods of implementing same.

### SUMMARY

Described herein, in respect to various systems and methods of process mapping on a graphical user interface, is a computer display of a computing apparatus configured to present a graphical user interface containing a plurality of graphical objects controllable by a controller (of the computing apparatus). Using at least one stored data set as input variables, a data analysis function is initiated to generate a graphical element output (e.g., a graph, chart, summary table, etc). A stored study object is also generated, which corresponds to the graphical element output and identified with the data analysis function and the at least one stored data set, whereby the stored study object is controller engageable to regenerate the graphical element on the user interface.

Initiating the data analysis function preferably generates a study object in an engaged or open mode, which includes displaying a data object element associated with the at least one stored data set, a data analysis function object element (e.g., a data analysis tool object element) and the graphical element output. In various embodiments, the method entails generating multiple study objects in engaged modes (“engaged study objects”), closing, reducing or otherwise transforming the engaged study objects to study objects in a stored mode (“stored study objects”). Each such stored study objects corresponds to a study object in engaged mode, and is identified to a data analysis function, store data set as input variables, and a graphical element output (i.e., all of which are associated with the corresponding engaged study object). In stored or reduced mode, the controller engageable study object is preferably presented on the user interface without the graphical element output, data object element, and\or data analysis function object element or, in other words, with these object elements in hidden mode.

Noting that the engaged study object identified to a project graphically presents information on analysis and data associated with or underlying a project, the presentation of a single study object in engaged mode may be referred to as a single study project map or project mapping. In further embodiments, multiple stored study objects are positioned on the user interface in mutual graphic association, whereby a relative arrangement of the study objects presents a multi-study project map. In one embodiment, the study objects are mutually graphically associated by graphical segments connecting the stored study objects, and more preferably, wherein a string of the stored study objects connected by such graphical segments indicate a chronological project flow. In one embodiment, the graphical segments are line segments connecting study objects. In another embodiment, the graphical segments are individual object elements representing a task and activity relevant to a study object(s). In another embodiment, the study objects are mutually graphically associated by presentation on a common graphical underlay (which may be referred to as alternate map views on the user interface). The graphical underlay may include graphical elements pre-identified to stages or phases of the project. The common underlay, with graphically associated and/or connected portions, graphically connect the study objects positioned thereon. Suitable underlays include a DMAIC or Lean Six Sigma phase project tracking worksheet and a Critical Question worksheet. The regions or elements in these worksheets are already defined and mutually logically and graphically associated before stored study objects are positioned thereon.

Also disclosed is a computer-implemented method of initiating a data analysis function on a graphical user interface of a computer display. The method includes presenting a graphical user interface on a computer display of a computing apparatus having a controller, where the graphical user interface contains a plurality of graphical objects controllable by the controller, including a tool object associated with a data analysis function and a data object selection region containing at least one data object associated with at least one stored data set. A tool object is selected (i.e., by the user or responsive to a request by a user) to establish a corresponding study object on the user interface. The at least one data object associated with the at least one stored data set is then enabled and the study object is engaged with the at least one data object on the user interface to initiate the data analysis function, whereby the at least one stored data set are input variables to the data analysis function and a graphical element (e.g., a chart or graphical representation) is displayed on the user interface as output to the initiated data analysis function.

Preferably, after engaging the study object, a storable or historical study object is generated. The historical study object corresponds with the engaged study object and is further engageable to display, at least, the output to the initiated data analysis function. The storable or historical study object is re-positionable about the graphical user interface, and further enegageable to display, at least, the output. Moreover, a plurality of said historical study objects may be positionable on the user interface in relative association to present a project map or critical through process map. In one embodiment, the study objects are positioned on a common underlay and thereby, mutually and logically associated by way of the common underlay. In another embodiment, the underlay is a two dimensional spatial underlay and may represent a temporal or logical setting.

A computing system is also disclosed having one or more processors, a display, and a memory coupled to the one or more processors. In this computing system, the memory stores program instructions executable by the one or more processors to display a graphical user interface on the display. The graphical user interface includes a data object selection region containing at least one user interface data object associated with a stored data set and displaying visual attributes corresponding to properties of the data set, including an attribute corresponding to data type. Preferably, the visual attributes include a first reflective of data type and a second containing a graphical display derived from the associated data set. For example, the data object may include a window having a histogram of the data set.

In another aspect, a non-transitory computer-accessible storage medium is provided. The medium stores program instructions computer-executable to implement a graphical user interface for presentation on a computer display. The graphical user interface includes at least one user interface data object associated with a stored data set, the at least one data object displaying visual attributes corresponding to properties of the data set. Further, the at least one data object is movable from the data object selection region to an analysis region to initiate input of the data set into a data analysis function.

Furthermore, a computer-implemented method is disclosed for process mapping on a graphical user interface of a computer display. The method presents a graphical user interface on a computer display of a computing apparatus having a controller, the graphical user interface containing a plurality of graphical objects each controllable by the controller, including a tool object associated with a data analysis function and at least one data object associated with at least one stored data set. Upon selection of a tool object and at least one data object (e.g., by a user), the data analysis function is initiated, whereby the at least one stored data set are input variables to the data analysis function and a graphical element is displayable on the user interface as output (graphical element output) to the initiated data analysis function. A corresponding study object is generated that is identified to the project, the initiated data analysis function, and the graphical element output. In respect to one or more sets of a tool object and a data object associated with a stored data set, the method repeats initiating the data analysis function and generating a corresponding study object, so as to generate a plurality of study objects common to the project. A plurality of the study objects identified to the project are displayed on the user interface in logical relation, thereby generating a process map for the project (also referred to as project map or project process map).

In another aspect, a computer-implemented method is disclosed for process mapping on a graphical user interface of a computer display. The computer-implemented method provides a computer display of a computing apparatus having a controller, the computer display configured to present a graphical user interface containing a plurality of graphical objects controllable by the controller. In response to user prompt and selections, a data analysis function is initiated to generate a graphical element output using at least one stored data set as input variables. A stored study object is also generated which corresponds to the graphical element output and is identified with the data analysis function and the at least one stored data set, whereby the stored study object is controller engageable to regenerate the graphical element output. The method further entails repeating said initiating a data analysis function for each of a plurality of stored data sets to generate a plurality of stored study objects. A plurality of these stored study objects are then positioned on the user interface, for display, in mutual graphical relation to generate a process map.

In another aspect, a non-transitory computer-accessible storage medium is provided for storing program instructions computer-executable to implement one or more graphical user interfaces for presentation of a process map on a computer display. The graphical user interface includes a plurality of stored study objects, each stored study object identifying a data analysis function and engageable to display a graphical element output to initiation of the data analysis function with a prior selected stored stat set as input variables. A plurality of the stored study objects is positioned on the user interface in mutual graphical association, whereby a relative arrangement of the study objects presents a multi-study project process map. In one embodiment, the study objects are mutually graphically associated by graphical segments connecting the stored study objects. Alternatively, the study objects are mutually graphically associated by graphical segments connecting the stored study objects, such that a string of stored study objects connected by graphical segments indicate a chronological project flow. Further yet, the graphical segments may be line segments indicating logic direction. Further yet, the graphical segments may include graphical object elements that are controller engageable to display additional graphical elements associated with the graphical object element. Further yet, the study objects may be mutually graphically associated by being mutually presented on a common graphical underlay. Further yet, such a graphical underlay may include graphical elements identified to stages of a project, each of the study objects being identified to said graphical elements. The graphical segments may also be serially connected critical question, study, and answer graphical objects.

Also disclosed is a computing system, comprising one or more processors, a display, and a memory coupled to the one or more processors, wherein the memory stores program instructions executable by the one or more processors to display a graphical user interface. Such a user interface includes a plurality of stored study objects, each stored study object identifying a data analysis function (e.g., by appropriate text or icon) and engageable to display a graphical element output to initiation of the data analysis function with a prior selected stored data set as input variables. Further, a plurality of the stored study objects is positioned on the user interface in mutual graphical association, whereby a relative arrangement of the study objects presents a multi-study project process map.

### BRIEF DESCRIPTION OF THE DRAWINGS

FIGS. 1A-1C are a simplified illustrations of a spreadsheet application-based user interface in the prior art;

FIG. 2 is a simplified block diagram of computing architecture suitable for use with exemplary embodiments;

FIGS. 3A-3B are simplified illustrations of basic elements of an exemplary computing system and method of data analysis according to embodiments;

FIGS. 3C-3D are simplified illustrations of user interface elements and techniques employed by certain embodiments;

FIG. 4 is a simplified process diagram of a method of data analysis according to an embodiment of the disclosure;

FIGS. 5A-5D depict exemplary computer-user user interface environments according to certain embodiments;

FIGS. 6A-6G depict exemplary computer-user interface environments according to certain embodiments;

FIGS. 7A-7F depict exemplary computer-user interface environments according to certain embodiments;

FIGS. 8A-8B depict examples of computer-implemented systems of progressive project data tracking in the prior art;

FIG. 9 depicts an exemplary computer-user interface for critical project mapping, according to certain embodiments;

FIG. 10 depicts an exemplary computer-user interface for critical project mapping, according to certain embodiments;

FIG. 11 depicts an exemplary computer-user interface for critical project mapping, according to certain embodiments;

FIG. 12 depicts an exemplary study object according to certain embodiments;

FIG. 13 depicts an exemplary computer-user interface for critical project mapping according to an alternate embodiment; and

FIGS. 14A-14F depict stages or versions of an exemplary computer-user interface for generating and\or presenting a critical thought map according to an alternative embodiment.

### DETAILED DESCRIPTION

The systems, methods, and user interfaces described are particularly suited for use or operation with a data analysis software application. A system presenting or containing such a software application may include data storage and access capabilities, analytical tool functionalities, and display facilities. The system may also benefit from a depository for storing and accessing historical results of data analysis.

As used herein, the term “data analysis” means the execution of a computer program or algorithm to access a target collection of data or information (“data source’) and to evaluate, manipulate, or organize the target data, so as to derive or extract useful information from the data and present the useful information in a form or format different from the original target collection. The presentation of the new information embodies the “results” of the data analysis, and may be conveyed through charts, graphs, and\or textual write-ups, all of which are considered “output.” Moreover, as used herein, the term “Study” or “Studies”, as it relates to “data analysis”, refers to the means by which or the tool(s) used to perform the data analysis, including the parameters of the analysis, the target data that is the subject of analysis. A “study” preferably includes output of the data analysis and/or user-added information associated with the study.

Also, as used herein the term “data analysis tool” refers to a computer-executable program or functionality for performing “data analysis” using target data as input. In the present descriptions of systems and user interfaces, the “tool” will be presented in a computing environment readily accessible to the user. For purposes of this disclosure, the term “data analysis function” means a computer program, tool, or other facility having the capability or the means to perform “data analysis” on target data. In a preferred environment, a tools library includes or provides access to an integrated suite of software facilities for data manipulation, calculations and graphics (“data analysis facilities”).

In one aspect of the present disclosure, a computer-user interface (and systems and methods) is provided that promotes the user's focus and actions on business or analytical task processes rather than computer-oriented issues such as running and navigating software applications and searching and storing files. The user interface, systems, and methods are particularly suited for implementation with software applications featuring data analyses, manipulation, and display. The disclosure introduces improvements to such user interfaces, and a system and method of data analysis, manipulation, and\or display via a computer display and interface, that focus less on the software tools and data locations and more on the mathematical attributes of the data, analyses on the data, and display of data and analytical results pertinent to the greater objectives of the user and/or further users. Accordingly, the improved user interface, and associated systems and methods, introduced herein may be described as taking a more object-oriented approach to computer-implemented methods of analysis and user interfaces, rather than an applications-oriented approach.

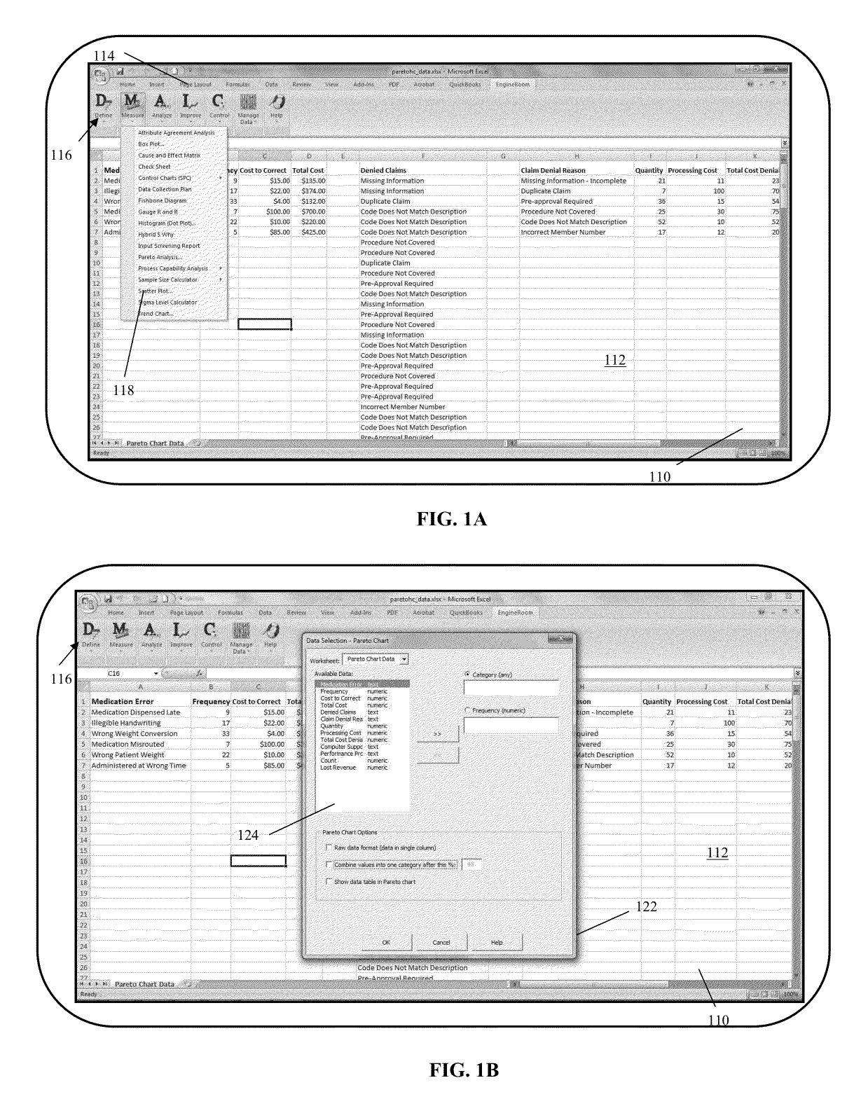

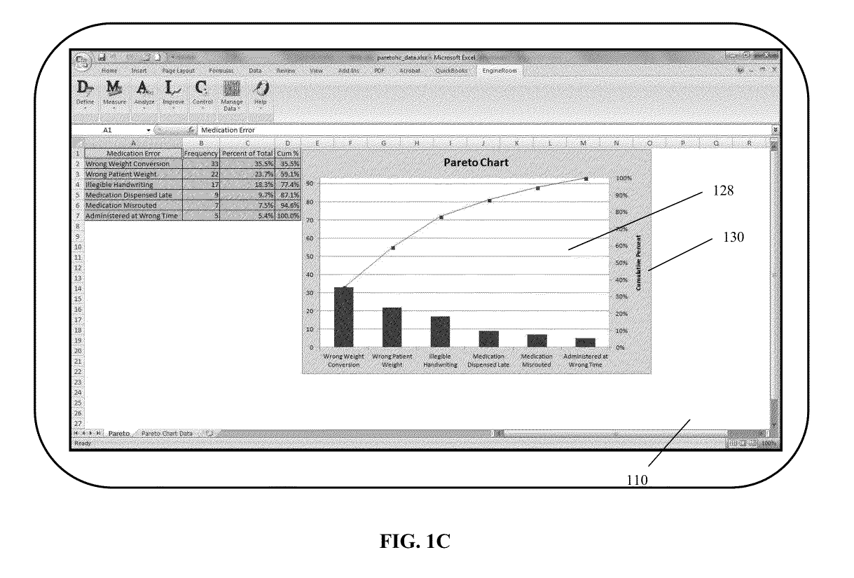

FIG. 1 depicts a user interface 110 for a prior art data analysis software application that may serve as background information for the present disclosure. An appreciation and understanding of the present disclosure's particular contribution to the art may be gained with reference to methods and functions associated with this type of data analysis software application. The user interface 110 depicted reflects features of a proprietary desktop-based application called Engine Room® data analysis software available from MoreSteam.com LLC in Ohio. The software is available as an add-in to a Microsoft Excel® platform. This software application is designed to support users implementing the quality improvement process termed DMAIC, which is a data-driven improvement cycle used to improve, optimize, and stabilize business processes and designs. With this application, a spreadsheet or worksheet provides a platform on which data are stored, edited, and arranged. As the application is intended to support a quality improvement process, the user interface 110 is particularly directed to user implementation of certain fundamental problem-solving tools commonly used to support process improvement efforts. As generally known, the worksheet 112 arranges data in rows and columns that define spreadsheet cells, and users may be given various options for interacting with and editing the data. New data are entered by highlighting a cell and typing into a window that appears above the spreadsheet. Also, the user may globally replace data, make computations on the data, or perform a number of functions.

As shown in FIG. 1A, the user interface 110 may be divided into three parts or regions: a menu bar 114 along the top margin of the user interface 110, a ribbon bar 116 below the menu bar 114, and the worksheet 112 below the ribbon bar 116. The menu bar 114 contains several text-based buttons which allow the user to navigate the application and interface with the Microsoft Excel® spreadsheet. When the add-in data analysis program is enabled, the ribbon bar 116 appears below the menu bar 114 and presents the data analysis tools available by way of pull-down menus 118.

FIGS. 1A through 1C provide snapshots of at least three of the various stages (and states of the user interface 112) navigated by a user to perform an analytical process on data stored on the worksheet 112. In this example, the user performs a pareto analysis using two sets of related data: (a) types of medication error and (b) frequency of error. As shown in FIGS. 1A and 1B, this data appears on the worksheet 112 while the user navigates the spreadsheet menus to find the pareto analysis function and apply it to the data. Parts of the worksheet 112 are often obscured, however, by menus or windows activated by the user. For example, the user must enable the appropriate tab in the ribbon bar 116 to reveal a pull-down menu 118. The user then finds and enables the pareto analysis tool in the menu 118, thereby opening a new data selection window 122 for preparing the pareto analysis. See FIG. 1B. Another window 124 inside the data selection window 122 lists the data sets in the worksheet 112 by name and type. The user scrolls through the list and finds the data set “Medication Error” among the eleven other data sets on the list, as it is aptly named and selects it for analysis. The user also highlights the data set “Frequency” which he thinks corresponds to the “Medication Error” data set. If the user is correct in his selection of data variables, the pareto chart 128 in FIG. 1C is created and appears in a new window 130 over the worksheet 112.

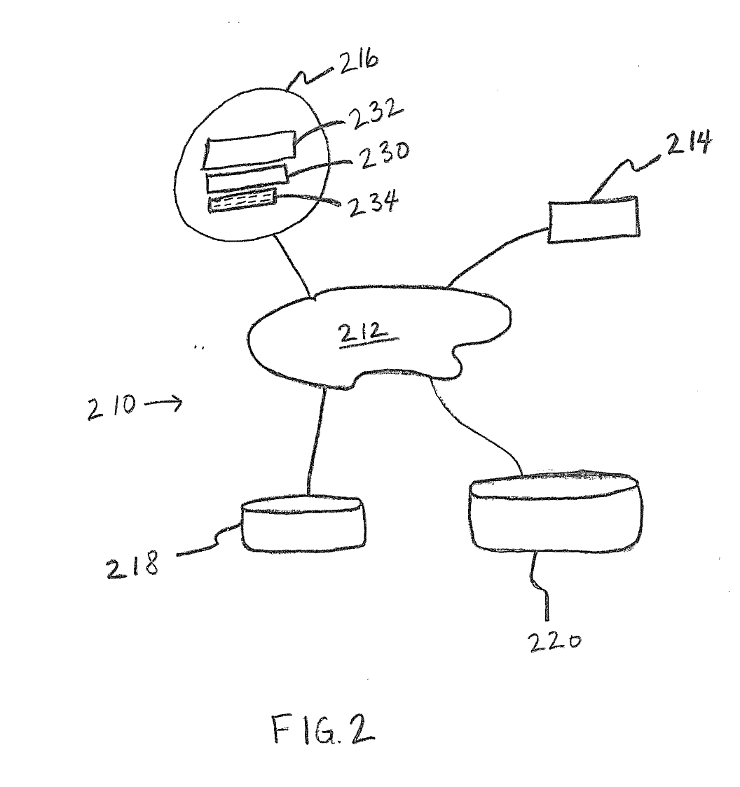

The present disclosure provides general and specific improvements and enhancements to the system and methods associated with data analysis software applications of the type described above and in respect to FIGS. 1A-1C. These improved and enhanced systems and methods are well suited for the computing architecture and system 210 depicted in FIG. 2. Specifically, the systems and methods are preferably implemented with a web-based system architecture that takes advantage of one or more networks 212 having one or more servers 214 and one or more client stations 216. The system 210 may also include a dedicated database server 218 for storing and manipulating client data and a dedicated server 220 for programs responsible for analytical processes and support. The data and program logic and functionalities of the software application may be shared among the various client stations and server devices in real time. Accordingly, the system may be described as employing cloud computing capabilities to perform or support the data manipulation and computation required by these software applications.

Preferably, details of the configuration and dynamic processes of the system 210 will not be apparent to the user at the client station 216. The web-based software application may execute and launch in a web browser on the user's client station 216, with minimal or no download and management of software modules. The user client station 216 preferably includes one or more processors 230 with memory to handle and share in the operating tasks of the software application, data storage or secondary memory, and a display 232 on which the user may interact with a graphical user interface for the software application. The user client station 216 also includes a control pointer for interacting with the user interface. Such a control pointer may be provided by a keyboard, a mouse, a touch-screen, a touch-pad, joystick, and other common devices, and various combinations of these devices. The client station in FIG. 2 is shown with a standard computer keyboard 234, but preferably will also include a mouse or other control device particularly adept at direct manipulation of objects on a graphical user interface.

It will become apparent to, and understood by, those skilled in the relevant art, that in alternative applications, the network 212 may be a local area network, a wide-area network, the Internet, or other suitable communications network. Additionally, the function of the client station 216 may be performed in these alternative applications by a mobile phone device, a tablet, a laptop, desktop, or other computing device (existing or future devices).

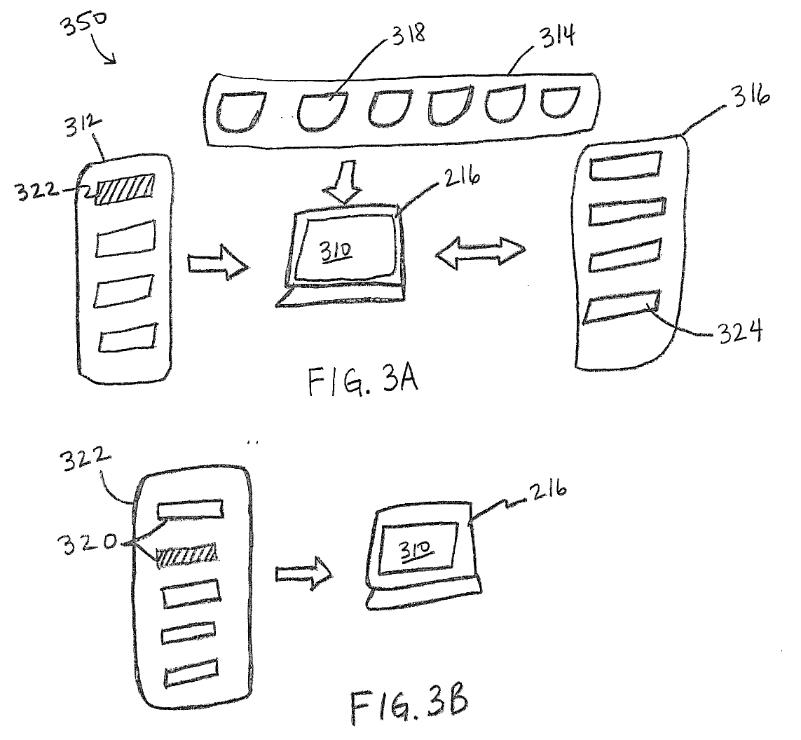

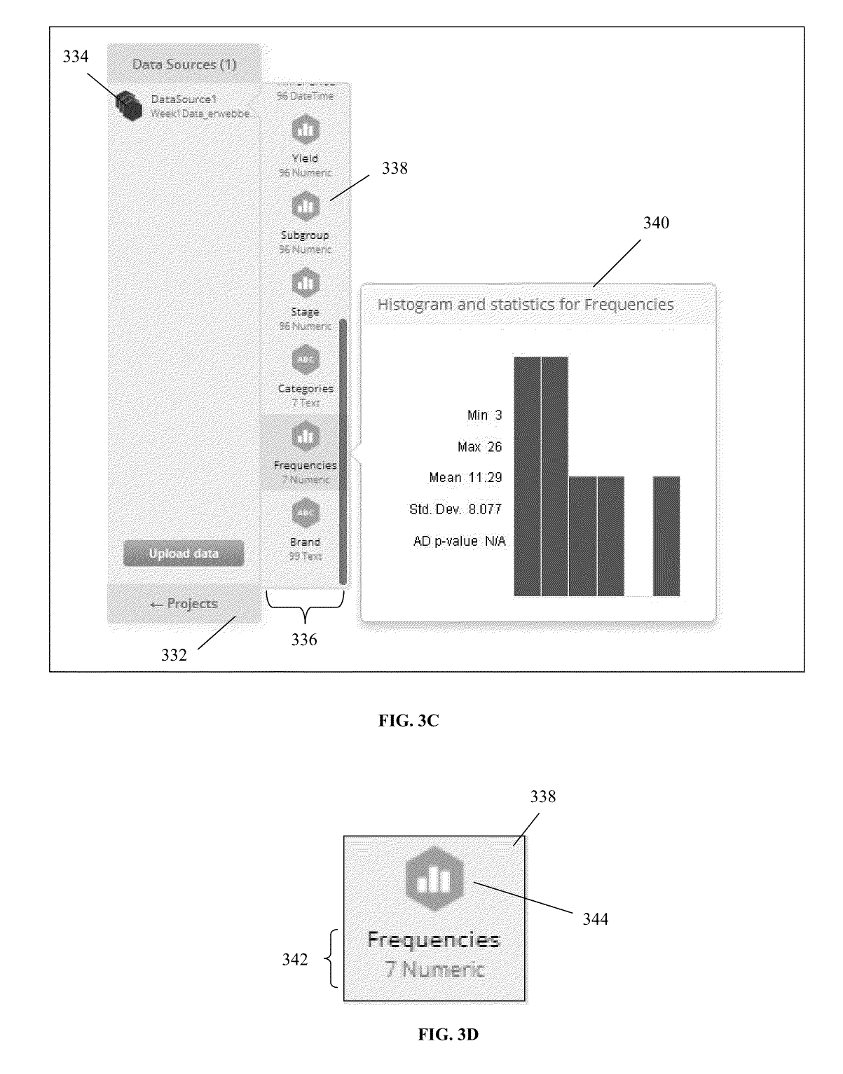

A data analysis software application and system according to the present disclosure may be described by the schematics of FIGS. 3A and 3B which represent the system's basic functionalities. Preferably, the user operates the client station 216 to implement the software application and to communicate with the system's various functionalities. The client station 216 may include one or more processors coupled to a system memory, and one or more input/output devices, including a cursor control device, keyboard, and display, (collectively referred to as “computing device”, “computing system”, or “computer apparatus”). Certain programs of the software application are loaded onto and reside in the computing device, and communicate with other programs and files through the web-based system 210. The client station 216 may also include a user interface module, a network-interface communication module, and additional data storage. To facilitate description, references to the software and its processes are usually made from the perspective of the user at the client station 216, without regard to the web-based system and the physical associations of dynamic processes, files, and programs.

A system model (system 350) embodying elements of the data analysis application and method includes a graphical user interface 310 accessible from computing device 216, a first collection or database of data appropriate as input for data analysis (Projects Database 312), a suite or library of data analysis tools (Tools Library 314), and preferably, a depository for analysis events or Studies 324 (Studies Database 316). The system 350 is configured such that the computing device 216 communicates with each of the Projects Database 312, the Tools Library 314, and Studies Database 316 through the Internet, as shown in FIG. 3A. Tabs 318 in the Tools Library 314 represent categories of Tools which are accessible by the user directly from the user interface 310. In the present software application context, the Tool (Tool function) is a callable unit of programmed instructions, procedures, routines or functions that may be initiated to perform data analysis (usually statistical analysis) on target data or file. The Tool or Tool function is accessible and deployable by the user via the graphical user interface 310. In one exemplary environment, the system and software application provides a tools interface to an integrated suite of software facilities for data manipulation, calculations, and graphical display (“data analysis”). More specifically, the tools interface connects the user to a separate “R” statistical environment on a server(s). As generally known, “R” is an open source software environment for statistical computing and graphics, available under a GNU general public license.

The Projects Database 312 in this case is merely a collection of discrete data sources each of which is commonly identified to and grouped by Project 322. Each Project is defined by parameters relevant to the user. For example, a Project may represent a quality improvement effort directed to a specific process in the user's organization. In this web-based system 350, computing device 216 generally extracts data from the Projects Database 312 and directs the data as input to a Tool function selected from the Tools Library 314. In exemplary embodiments, the selected Tool function will perform data analysis on the data and deliver an output to or through computing device 216. Computing device 216 may also deliver output to Studies Database 316 or some other external facility, such as a printer, data storage, or another client station. As shown in FIG. 3A, computing device 216 may receive data and information from the Tools Library 314 and from Studies Database 316.

It should be noted that data and information associated with a Project does not necessarily mean that the data and information physically reside in a single database. The Projects Database 312 in FIG. 3A simply represents and illustrates that, from a functional perspective, the collection of Projects or, more specifically, the collection of data sources, is logically arranged and accessible in the software (e.g., via the user interface 310). In most operating modes, a user typically deals with, and makes active, a specific Project in the Projects Database 312 (which is shown in shade in FIG. 3A). Thereafter, computing device 216 communicates specifically with Data Sources 320 identified to the active Project. This is illustrated in FIG. 3B, wherein Data Sources 320 identified to the active Project are arranged and displayed in a Data Source Database 322, and made accessible to computing device 216 and to the user via user interface 310.

For purposes of the present disclosure, a data source is understood to contain one or more sets of data or information just as a spreadsheet may contain specific collections of data arranged in rows under a column. The data identified to a set will be of a specific type or category, such as text or characters, time and date, and numeric information, and may be arranged in random or in a predetermined manner of importance. So, in summary, data and information are grouped together in data sets, data sets are grouped together by data source, and data sources are grouped together by Project.

In this embodiment, Study 324 refers to a stored computing event—the initiation of the Tool function to perform data analysis on target data. Thus, a Study 324 stored in Studies Database may include the Tool function selected and any relevant parameters, the target data, and the results or Output, user-associated data or information (including relevant conclusions), and time-stamped history. In certain embodiments, information in a Study will simply include reference to the Tool function and target data such that the Output may be readily reproduced by the original user or a new user. Output may include charts, graphs, tables, listing, and other arrangement or display of information resulting from the data analysis. The study may also include user-associated information such as notes, conclusions, or user information.

FIGS. 3A-3B reflect, therefore, the interrelation between the user and computing device 216 and the basic elements or objects that the user and computing device 216 manages. The elements include various levels or layers of data and tool functions, and studies. To facilitate management of these elements or layers, and the performance of data analyses, the present system 310 employs a particularly advantageous graphical user interface 310. In preferred embodiments, the user interface 310 utilizes user interface object elements to represent data elements, tool functions, and\or other system elements to facilitate a user's decision making process and management of these system elements. The user interface 310 may also employ such object elements to represent and convey action between elements, including the initiation of a Tool function to perform data analysis on a selected data set. This is sometimes referred to as the engagement of an object representing the Tool function with an object representing a selected data set (i.e., input data variables to the tool function). In addition, object elements used to represent data or tool functions are provided visual attributes that correspond with and thereby, convey properties of the underlying data or information. In the present computing environment, wherein the user has to consider layers of tool functions and layers of data, or even Studies, the objects assist the user in selection and decision making processes.

FIGS. 3C and 3D illustrate features of an exemplary user interface environment of the disclosure, and how the relationships of system elements in FIGS. 3A-3B are translated onto the user interface 310. Data Source Database 322 and Data Sources 320 from FIGS. 3A-3B are represented as user interface objects that the user can manipulate to translate the data among system elements and across the user interface environment, and to initiate action. In this example, Database 322 is represented by a user-activated container panel 332 while Data Sources 320 identified to the Database 322 are represented by icons 334. The Data Source icon 334 may be enabled to reveal yet another container panel—a data set panel 336. Each tile object 338 in panel 336 represent a data set of the data source 320 (e.g. a row of numbers in a worksheet that provides data source 320). In an important aspect, data set object 338 is provided with visually observable attributes that correspond to properties of the underlying data set. As shown in the example depicted in FIG. 3D, data set object 338 includes a hexagon icon 344 as well as text 342 revealing the name, data type, and count. As will be shown below, the hexagon icon 344 is itself a user interface object and may be moved about the user interface 330 to translate the underlying data set to another object or system function (e.g., a tool function). The hexagon icon 344 visually associates with the data source object 334 as well as a data variables field that is described below. As used herein, one hexagon icon or object is, in addition to being visually associated with another hexagon icon or hexagon, described as substantially corresponding or matching with another hexagon icon or object because of the visual similarity between the two (as opposed with other objects) and because one of the icons or objects can be moved into the other to initiate an action.

In a further aspect, the data set object 338 may be enabled to reveal summary analytical information and\or other properties of the data set. This is shown in FIG. 3C, where tile 338 is enabled by hovering a pointer about tile object 338 to reveal window 340. Window 340 may contain such summary or composed information as statistical data, charts, and tables reflecting properties of the data set. As used herein, the term summary or composed information or properties refer to information different from the data or information in the data set, but may be information or data derived from the data set. For example, summary analytical information may result from preliminary statistical operations performed on the data set, such as determining minimum and maximum values, means, average or standard deviation. For some data sets, a presentation of the data sets or information may also be provided, for example, in a list or table.

Thus, information on an underlying data set may be available upon visual review of data set object 338—without having to open or view underlying layers of data elements or the underlying data set. Additional and more detailed properties may also be obtained by activating the window 340. These properties may be previewed without the user having to select and initiate data analysis on the data set. These visual clues may be used, for example, to confirm a match of the data set for use as input for a particular tool function. Additionally, the properties provided in window 340 may also help the user determine the appropriateness of a tool function for the data set (e.g., the degree of data normality or the AD p-value). Use of these clues may prevent confusion and time wasted testing data sets that are incompatible with selected tools or, because of their properties, are not likely to produce information useful to the process improvement effort.

Referring back to FIG. 3A, the system 350 provides a library 314 of data analysis tools for the user. The tools are arranged and categorized in a manner convenient to the user, but more significantly, and in furtherance of the object-oriented approach, in an arrangement pertinent to the subject, event, or circumstance relevant to the user task. In the example, the software application is provided as support for a quality improvement process, where the results of data analysis are intended to guide the user through various stages of the improvement effort. The improvement process is characterized by five stages: Define, Measure, Analyze, Improve, and Control. The tabs of a menu bar are defined literally by these stages of the process, rather than the tools themselves. The tools remain hidden in pull-down menus associated with each stage. In this way, the user's perspective remains on the real-world tasks and not on the mechanics of the system and software applications. With knowledge of the Project, the user is typically aware which stage of the process is pertinent, and thus, which tab along the menu bar is likely to provide useful or target tools in a pull-down menu. In some instances, the user may be led to a particular stage or to search for certain types of tools, and selects a tool after considering the array of tools presented.

A user selects a tool from a pull-down tool menu to perform data analysis relevant to the active project and also selects the data set(s) that will serve as input to the tool. This exercise of the tool on the selected data sets, as well as the results of the tool implementation, are identified to a Study, and then stored in Studies Database 316. The properties of the Studies accessible from the Studies Database 316 include information on the tool function implemented, input to the tool (e.g., data sets) and other parameters, user-added information, and the results or output of the analysis, which may comprise of charts, new data, and newly generated data and information. As will be illustrated below, an object in the Studies Database 316 may be enabled to reveal another object reflecting the underlying Study.

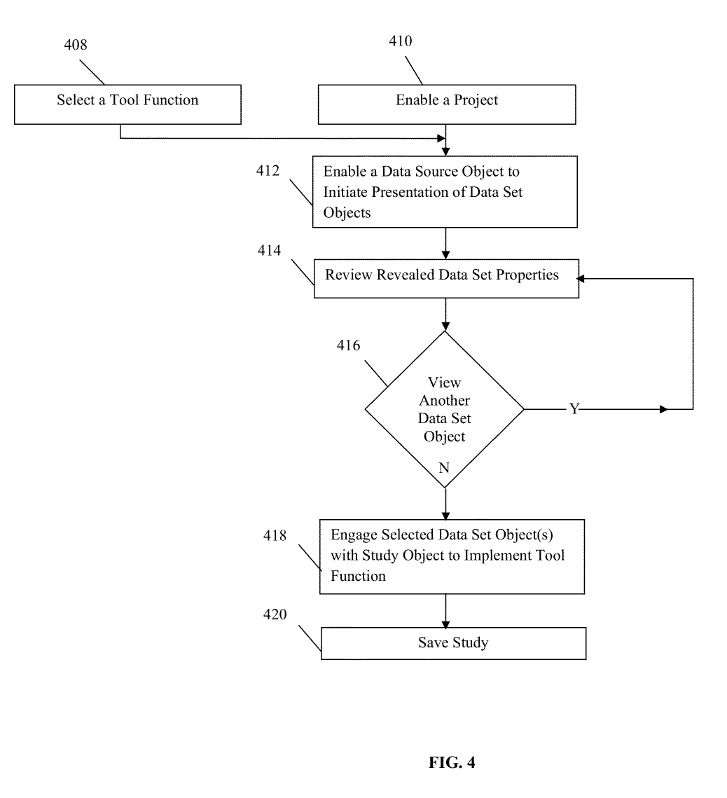

FIG. 4 illustrates an exemplary method of performing data analysis and/or generating a project study according to the present disclosure. The method chosen for illustration is one that utilizes the various system elements identified in FIGS. 2 and 3 by way of a graphical user interface and from the perspective of the user at a client station. The method may be initiated by the user selecting a tool function (408), which in actuality entails the user enabling a tool object on the user interface. In some embodiments described, the user interface requires the user to first select a Project phase, which in turn, reveals a pull-down menu of tool functions relevant to the project phase. The user enables a tool object from the pull-down menu by highlighting, double clicking, and/or dragging the tool function object to a workspace of the user interface. In one aspect, the tool selection also establishes a study object in the workspace, which provides the user with certain properties required of the data variable(s) (which are input to the tool function). The study object in this case is a “dynamic” object that evolves and captures additional information as the user progresses through tasks and projects.

In this embodiment, the user enables a Project (410). A list of established projects may be presented to the user, in which case the user selects and enables one of the projects. Alternatively, the user enables a new project which entails uploading one or more new data sources and naming the new project. In either case, by enabling a project, one or more data source options are presented to the user, preferably, as data source objects in a data sources election region on the user interface.

After considering the data source options, the user enables (and selects) a data source object (412). This initiates presentation of data set objects (in a data set selection region) that represent underlying data sets identified to the enabled data source. In a unique aspect, the data set objects have visual attributes that correspond to properties of the underlying data sets. For example, the data set objects may incorporate descriptive icons with both text and figures that signify properties of the underlying data sets. The user can, therefore, consider the underlying data set for use by reviewing the data set objects and the properties indicated for the data set (414) and in further view, of the properties of data variable(s) set forth for the selected tool. In further embodiments, to review additional properties of the data set, the user may enable any data set object to reveal a window containing additional properties. As discussed above, the additional properties may be analytical information derived from the data set, as well as a presentation of the actual data or information in the data set.

With information on the properties of the underlying data set, the user's decision to select the data set for analysis (or a tool function to initiate) is made easier. Either way, the user may consider viewing (or evaluating) another data set object (416). If the user decides against using the data set, the user simply discards the data set, moves the pointer to another data set object, and reviews the properties of its underlying data set (414). If, on the other hand, the user selects the data set, the user can move the data object into the workspace and toward the study object. To implement the selected tool function with the selected data set as input, the user engages the selected data set object(s) with the active study object (418). This is managed by simply dragging the data set object(s) into the workspace and attaching it to the active study object, which automatically initiates the tool function. In further embodiments, the study object will also have visual attributes providing clues as to where the selected data object should be positioned. Visual attributes of the study object may also indicate if additional data sets are required, in which case tool implementation is incomplete. The user can go back to the presentation of data set objects (e.g., data set panel) to review and enable additional data set candidates.

When the study object has engaged all required data set objects, the tool function is initiated and the output is displayed. The user can review the output on the user interface, and if not satisfied, modify the study by adding, deleting, and\or substituting data set objects. In any case, the study object is automatically updated, including the output associated with the study object. By closing the study object, it is automatically saved in the Studies Panel (420). The study object (and study) may also be saved by closing the study object at any time after tool function selection.

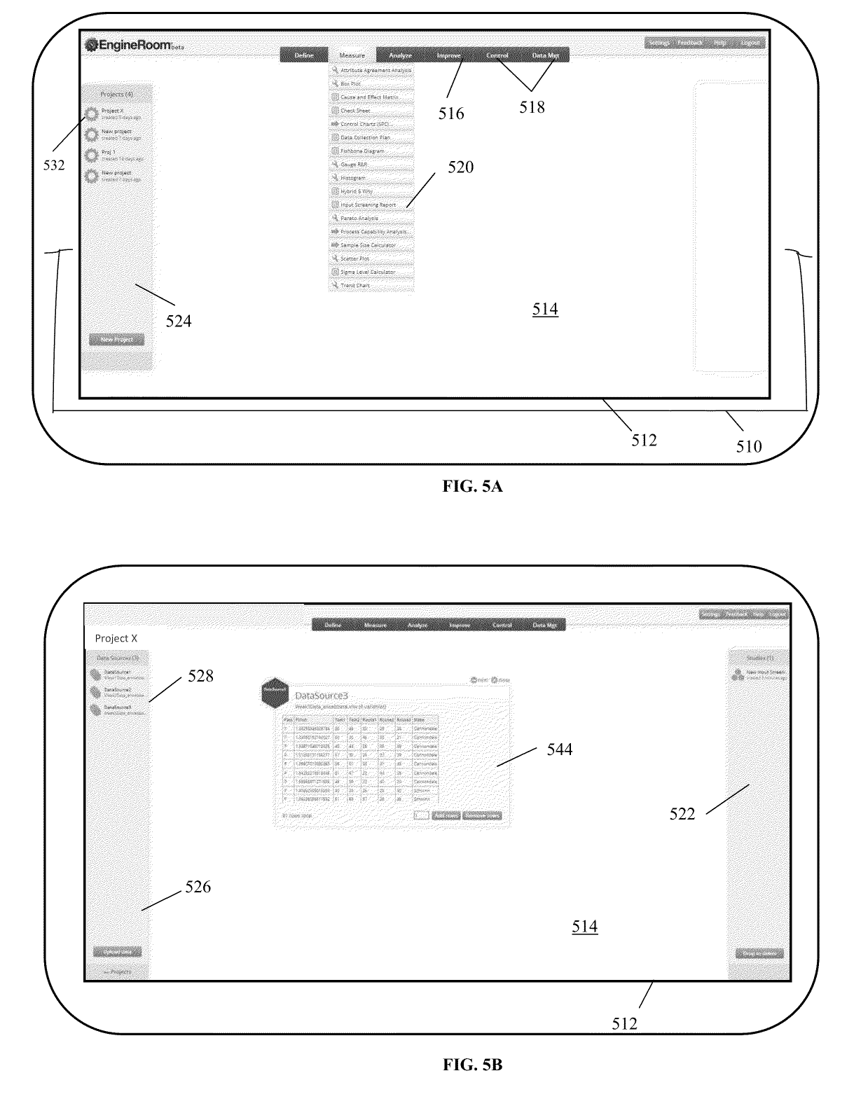

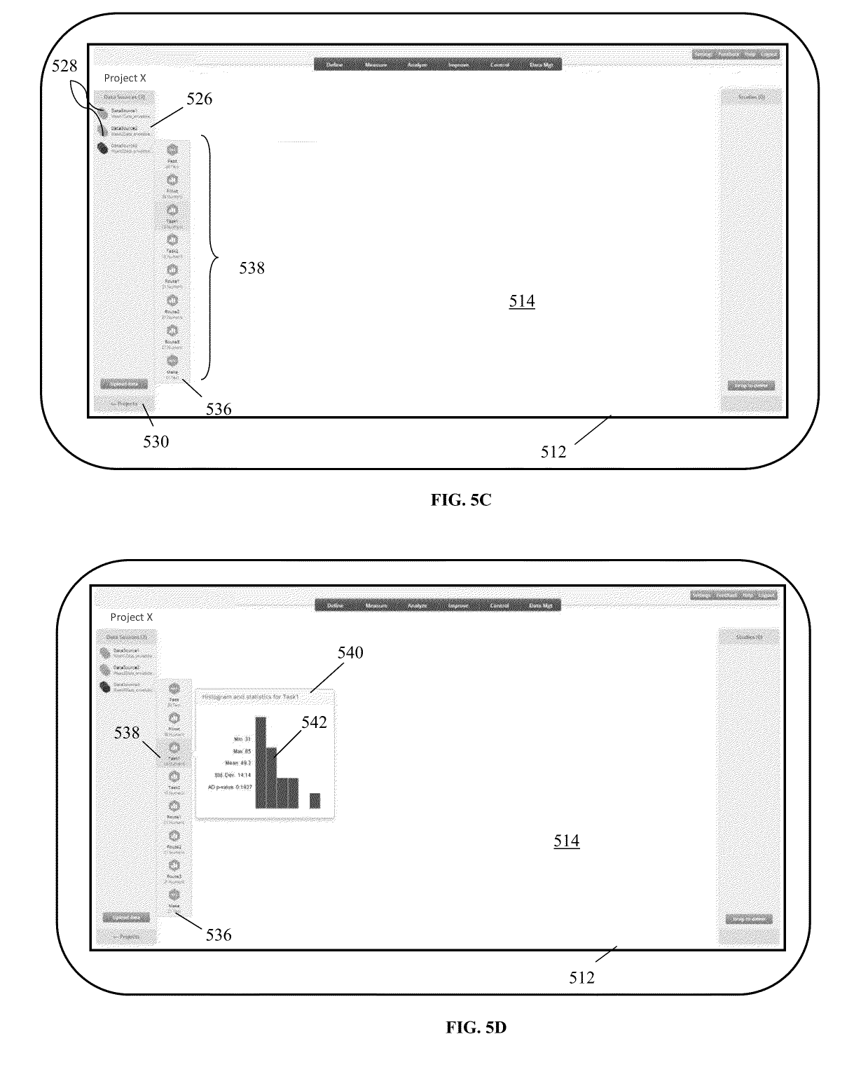

In accordance with the present disclosure, the methods of data analysis an\or presentation described herein, and related methods, including the operation of one or more segments of a data analysis software application may be improved and enhanced by employing a system and a computer-user interface as will now be described with reference to FIG. 5.

Exemplary Graphical User Interface(s) and Method of Implementing Same

FIG. 5A depicts a computer display 510 and a graphical user interface 512 presented thereon, which are suitable for the data analysis software application and for implementing steps and methods previously described in respect to FIGS. 3-4. As with most computer user interfaces, the user interface 512 of this software application may be navigated, engaged, and changed through use of a keyboard and control pointer such as a mouse, cursor, or equal (not shown). These control devices are specifically used to manipulate a plurality of graphical user interface elements or widgets. In one aspect of the disclosure, the user interface 512 preferably employs several types of widgets to facilitate the user's management of projects and data sources and selection and employment of an array of data analysis tools. These widgets include menus, toolbars, containers such as windows, panels, and palettes, icons, buttons, and other common user interface elements. The present graphical user interface favors an object-oriented design (i.e., as opposed to an application-oriented design), whereby the user interacts explicitly with objects that are intuitive representations of the entities in the domain relevant to the application. In the embodiments described herein, these user interface objects may represent projects, data sources or data sheets, data sets, tools and tool functions, and studies, among other things. In one enhancement of the prior art, the user interface employs icon views (or simply, icons) as an object element and to represent instances of an object, but also to signify certain properties or attributes of the entity represented by the object. In further embodiments, the user interface employs combinations of icons, property views and composed views in an object to inform and aid the user in selecting an object among other like objects.

The interactive user interface 512 includes a canvas on which a workspace 514 is preferably centered for convenient access by the user. In this embodiment, a horizontal Task Menu 516 is positioned along the upper margin above the workspace 514. The Task Menu 516 comprises several tabs 518 each distinctly representing a working or project phase of the DMAIC quality improvement process. The data analyses tools available to the user are allocated among the project phase tabs 518, with tools being assigned to the project phase(s) under which it is commonly associated or used. Clicking on a tab activates a pull-down Tools Menu 520 that presents a sub-array of the tools commonly used in that phase. In this embodiment, the system provides an interface with a suite of statistical and graphics display facilities in the “R” environment (under an open source license). Table 1 below provides a sampling of common data analyses tools that are integrated into the exemplary software application and which are particularly suitable for use with presently described systems, methods, and user interfaces.

TABLE 1
Sample of Data Analysis Tools and Functions

| | |
|---|---|
| Histogram | Trend Chart |
| Box Plot | Pareto Analysis |
| Histogram | Scatter Plot |
| Simple Regression | X Bar and R/S Chart |
| Anderson Darling | Arc Sine Transformation |
| Log Transformation | Hypothesis Testing |

The user interface 512 is further equipped with a container panel called the Projects Panel 524 to the left of the workspace 514 (a project selection region of the user interface 512). The Projects Panel 524 contains one or more objects 532 each representing a Project. As described previously, the Project refers to a collection of data sources, and in some embodiments, a collection of Studies. The object 532 used in this interface includes a gear icon and text that is descriptive of the Project. When a new project is indicated, data for the project may be uploaded as one or more data source files from an external spreadsheet (for example). For each data source file uploaded, a data source object 528 representing the data source file appears in another container panel or Data Sources Panel 526 (a Data Source selection region), as shown in FIG. 5B. Creating a new project also establishes a corresponding Studies Panel 522 to the right of the workspace 514 (a studies selection region). As alluded to earlier and further explained below, the Studies Panel 522 houses the elements of a data analyses event or Studies (i.e., wherein a data analysis tool is implemented and generates analytical results). By dragging and dropping a data source object 528 into the workspace 514, the underlying file—the worksheet 544—appears, displaying data stored in the worksheet. As with traditional worksheets, the user can interact with the worksheet and may edit its cell contents or its titles. For existing projects, editing the contents of a data source may result in changes to Studies that used data from the data source.

The user interface 512 in FIG. 5C is shown in an early or initial mode of operation under a selected Project. In respect to the process illustrated in FIG. 4, the user interface status in FIG. 5C may be presented to the user during the step of “enabling a data source object to initiate presentation of data sets objects.” In this description, the term “enabling” means to prompt, signal, or activate a user interface element by clicking on, highlighting, hovering about, or otherwise changing the status of the element and initiating a response from the user interface 512. The Data Sources Panel 526 displays a plurality of data source objects 528 each representing a data source identified to “Project X”, one of which is highlighted to indicate being enabled. A project button 530 located along the bottom margin of the Data Sources Panel 526 is operable to shift or transform the container panel 526 between two views or modes. In the mode depicted in FIG. 5C, the container panel 526 is identified to a specific project and contains the data sources of the project. In a second view or mode initiated by clicking the project button 530, the container panel 526 houses the various Projects pertinent to the user. In this second view, an array of Projects is displayed in the Panel, including Project X. See e.g., FIG. 5A. When Project X is enabled by a single mouse click, for example, the panel rotates or transforms to the panel view in FIG. 5C, which is specific to Project X and displays data source objects 528 identified to Project X.

In this exemplary user interface 512, each data source object 528 is presented as an icon featuring multiply stacked and offset hexagons. The stack is accompanied with text associated with the data source, including the data source name. The reference to multiple hexagons corresponds to the data sets contained in the data source, which are represented individually by a hexagon icon. Thus, the display of multiple hexagons may suggest to the user that the object refers to multiple data sets.

In one aspect of the disclosure, the user enables a data source object 528 (within the Data Source Panel 526) to reveal properties of the underlying data source file. The properties are conveyed in one view and without reproducing the contents of the data source file. A container sub-panel, referred to as the Data Variables Panel 536 (in Data Variables Selection region of the user interface 512), pops up beside the Data Sources Panel 526 and contains an array of data objects or data variables objects 538, as shown in FIG. 5B. The array may reflect the arrangement of data sets (variables) stored in the data source. Here, the data objects 538 are referred to as “data variable objects” because, when this view of the user interface is active, the user is typically contemplating use of a data analysis tool and reviewing the data source for data sets to be used as input data variables to the tool function. In an important aspect of this user interface 512, each data variables object 538 presents, in an efficient and concise fashion, multiple properties of the underlying data set, which the user can review. In this respect, the object 538 is described as having visual attributes that correspond to properties of the underlying data set. As previously shown in FIG. 3D, the data variables object 538 is a tile that serves as the platform for multiple descriptive elements. First, the tile showcases a hexagon icon with a graphical symbol signifying a data type—numeric, date and time, or text. Secondly, the tile includes text providing a name description, data count, and data type of the underlying data set. So, with this view of the Panel 536, the user may be able to eliminate data sets from consideration or determine the viability of a data set for tool implementation and study. For example, if the user expects a small file of numeric data, objects referring to TimePeriod data or a Subgroup file with a hundred items may be readily eliminated from further consideration.

In any event, positioning the pointer about (and hovering over) a data variables object 538 automatically displays a statistical summary attributable to the underlying data set. Specifically, this user action initiates a pop-up object 540—a window summarizing the underlying data set, as now shown in FIG. 5D. For example, enabling the third data variable object 538 automatically displays a histogram 542 and statistical information pertaining to the selected data set. In this window 540, the statistical information includes maximum, minimum, mean, standard deviation, and an Anderson-Darling p value. In alternative embodiments, other properties of the data set may be shown in this view. In some applications, only summaries and information particularly relevant to a selected tool function, for example, may be revealed. The Data Variables Panel 536 provides, therefore, additional and preliminary visual clues on the underlying data sets. It should be noted as well that the additional information provided would not be readily available to the user on review of the raw data. As mentioned previously, providing such information to the user facilitates tool selection and comparisons, among other things. In some applications, the summary information may suggest to the user what tool function may be helpful or simply prompt the user to select a tool function to analyze particular characteristics summarized or suggested by the summary information. For example, the degree of normality of a data distribution reflected in a histogram or the AD p-value may indicate to an experienced user the applicability of a hypothesis testing tool or other tool functions. Other summary information may suggest to another experienced user the need for certain data analysis to possibly reveal important information embedded in the data or to modify or transform the data to a format that is more informative to the user.

Generating a Study: Box Plots

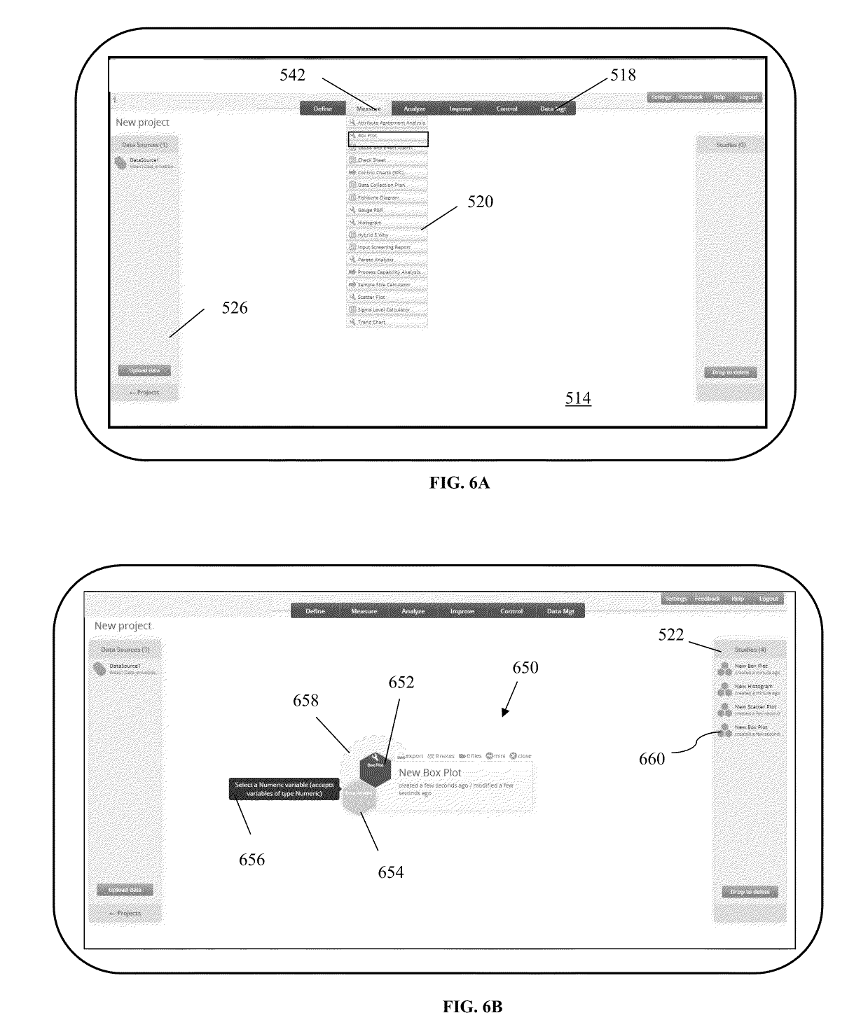

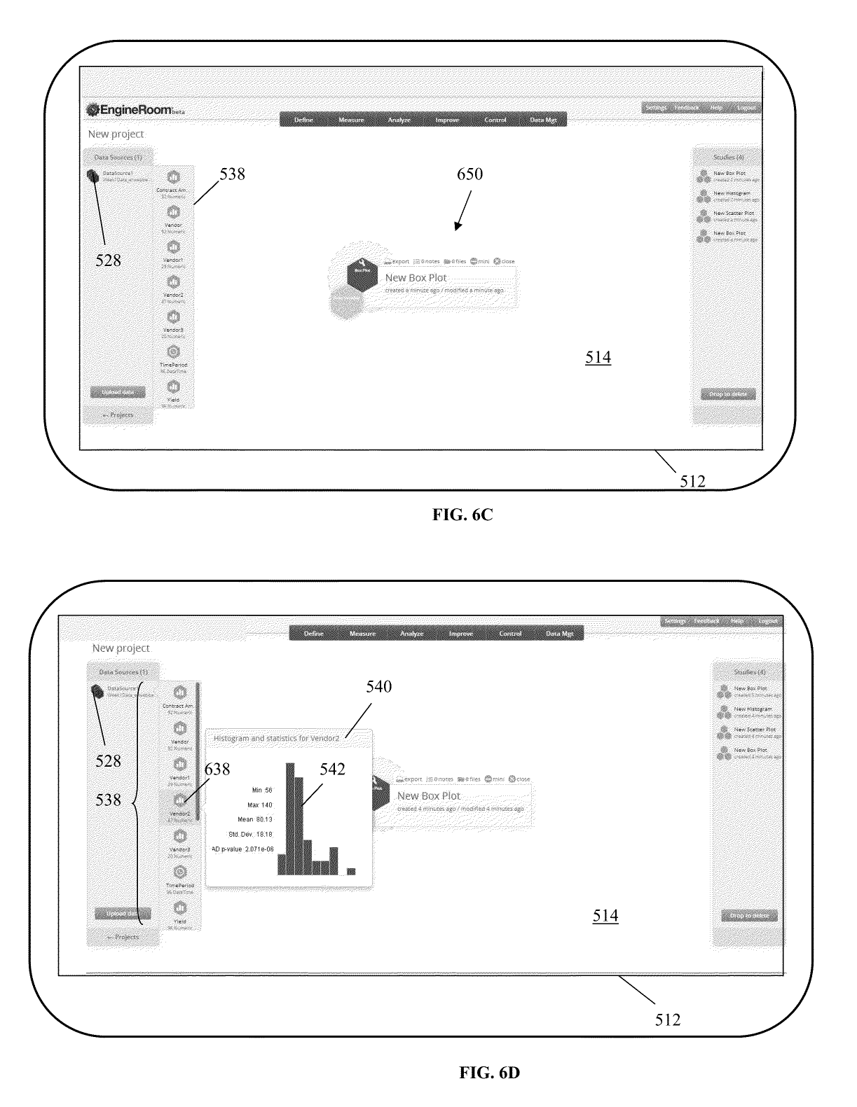

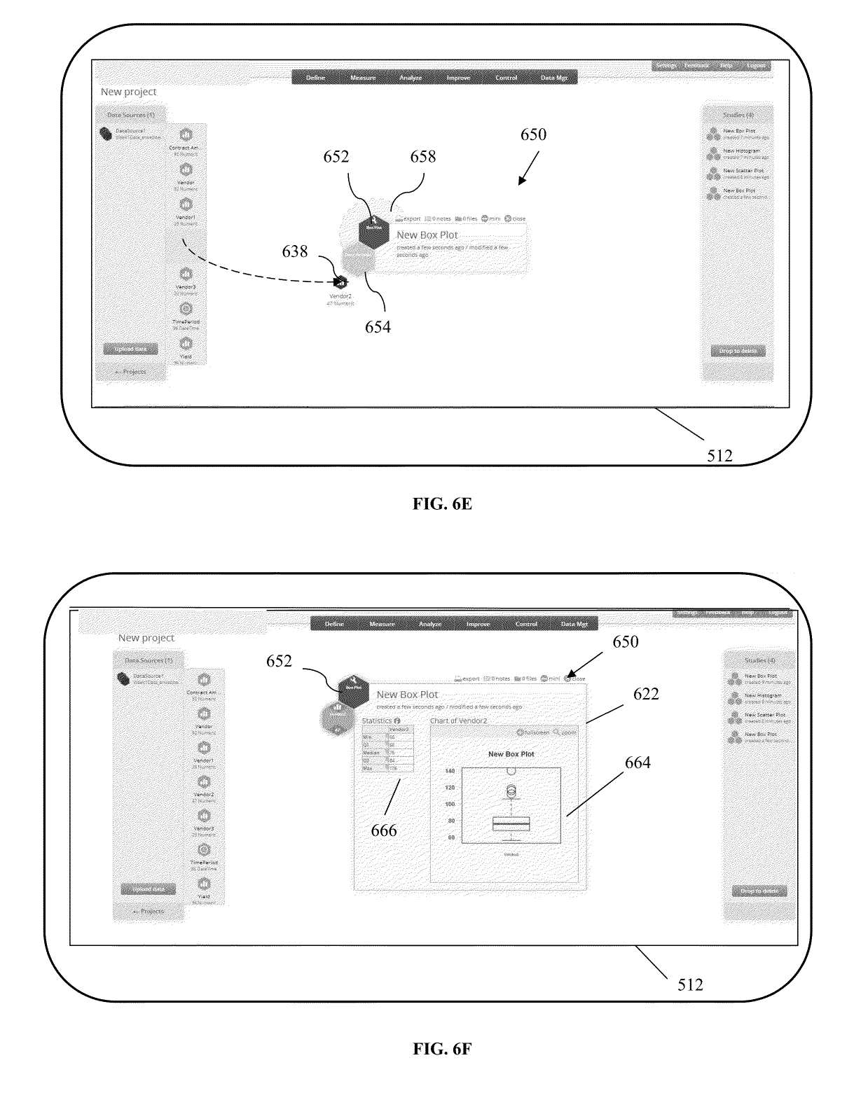

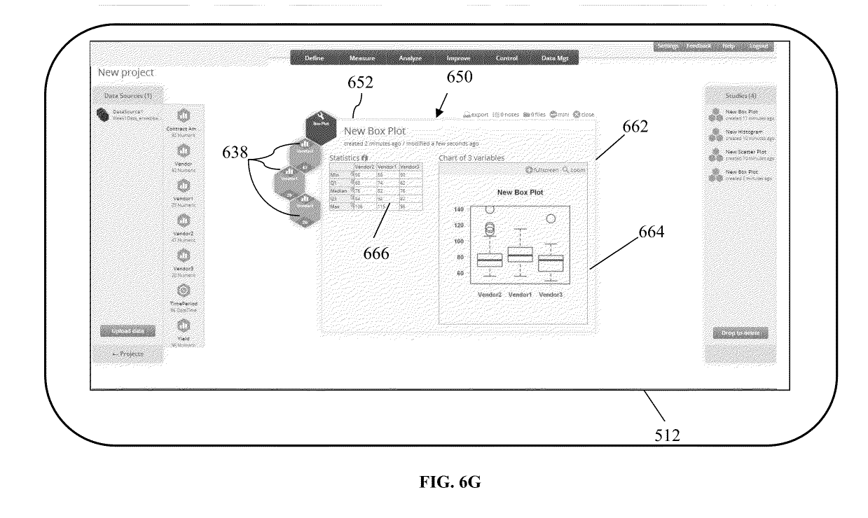

FIGS. 6A-6G depict various states of a graphical user interface 612 through which a method of data analysis is performed, at least in part (wherein like reference numerals are used to indicate like items). In this example, the user intends to generate a box plot for a certain data set. Referring first to FIG. 6A, the user navigates the Tools menu bar 518 and clicks on the Measure tab 542, which activates pull-down Tools Bar menu 520 containing the Box Plot Tool. In this embodiment, the Box Plot Tool function graphs the distribution of numeric variable while also displaying summary statistics. To activate, the user either clicks on the button for the tool or simply drags and drops the button in the workspace 514. In either case, a new study object 650 representing a data analysis event employing the box plot tool function appears in the workspace 514. See FIG. 6B.

An icon for the new study object 650 contains a central hexagon (a Box Plot icon 652) laid over a circular background 658. The circular background 658 is preferably of a light shade and has a dashed circumference, which indicates an incomplete or pending status of the study object 650. Furthermore, the study object 650 includes at least one data variable field object 654 signifying a data variables input requirement. This object 654 is presented on the outside of the tool object 652, and over the dashed perimeter of the circular background 658. The data variables field object 654 is distinguishable from the tool object 652 not only by its “data variables” label, but also by color. In this embodiment, it is of a color much lighter than the dark tone of the tool object 652. The hexagon-shaped data object 654 is a data variable field that is configured to draw and accept another hexagon object (e.g., one being passed in proximity). Notably, the data variable field 654 is of the same hexagon shape as the movable hexagon icon of data objects 538 in Data Variables Object Panel 536.

When a control pointer is hovered over the new study object 650, a tool tip box 656 pops up next to the study object 650. In this embodiment, the tool tip box 650 informs the user of the data type appropriate for the input into the data variable field, which in the illustrated example calls for a numeric variable.

As shown in FIG. 6B, a corresponding study object 660 is automatically established in the Studies Panel 522 when the Box Plot tool is selected and brought to the workspace 514 (i.e., when new study object 650 is established). The saved study object 660 in the Studies Panel 522 includes a hexagon honeycomb icon and text identifying the type of analysis (“box plot”) performed and date or elapsed time since the study was established. As with many of the object elements employed by the user interface of the disclosure, the hexagon honeycomb object 660 physically matches other associated object elements—in this case, the new study object 650. As mentioned previously, the Study may be recreated by simply dragging and dropping the saved study object 660 in the workspace 514. The Study can also be modified once placed active in the workspace 514.

With some information on the properties of the data variables (i.e., numeric type) required for Tool function input, the user navigates the pointer to a data source object 528, thereby enabling it and prompting the associated Data Variables Object Panel 536. The user looks to and reviews this Panel 536 to match possible data variables to the active Study. In the user interface environment, this means matching one of the data variable objects (hexagon) 538 from the Panel 536 with the data variables field object (hexagon) 654 in the study object 650. Among other things, the user looks for a data variables object 538 that signifies a numeric type. The user may look, as well, to the name of the data set. The content associated with a data variables object should eliminate some candidate data objects for consideration. Here, the user enables the “Vendor Data 2” data variables object 638, which type is numeric, and activates its Summary Window 540. See FIG. 6D. After review, the user drags the data variables object 638 toward study object 650 and near data variables field 654 (see FIG. 6E), where upon release it is automatically pulled into and contacts the data variables field object 654. The data variables object 638 is said to have been moved substantially into the data variables field object 654, and on release, is attached to the tool object 652. Data variables object 638 and new study object 650 (and alternatively, tool object 652) are said to be engaged at this point. Notably, the dash circle background 658 disappears which, for the associated single variable Tool function, signifies completion of the Study formula.

More importantly, with the engagement of study object 650 by data variables object 638, the Tool function is simultaneously implemented to perform data analysis on the target data. As a result, output window 662 is generated next to tool object 652 and, in one respect, made a part of study object 650. Window 662 includes, of course, a box plot 664 of the target data (data set underlying data variables object 638) as well as box 666 which contains summary statistical information on the data set. See FIG. 6F.

The study object 650 may be modified on the user interface 512 in any number ways, thereby modifying the Study. In the illustrated example, the study objet 650 may be appended with additional data variables objects 638. With each appendage, the Tool function is initiated for the additional target data and the box plot 664 and summary table 666 are appropriately modified. The study object 650 is configured such that each of the additional data variables objects 638 may be attached to other data variables objects 638 or replace and dislodge other data objects 638. When multiple data variables objects 638 are used, these are positioned contiguously to the study object 650. The order of representations on the box plot 664 and summary table 666 will automatically rearrange to match the relative positions of the data variables objects to new study object 650. Thus, data or output in window 664 may be manipulated by simply positioning the corresponding data variables objects 638. In FIG. 6G, two more data sets have been selected for data analysis by attaching their corresponding data variables objects 638 on study object 650. Almost intuitively, the multiple data variables objects 538 attach together and are of the same color, signifying their common data type and input to the tool function. The objects 638 are described as being in contiguous positional relationships, in respect to one another and with tool object 652. In the alternative, replacing a previously integrated data variables field object with another data variables field object automatically updates and replaces the analytical results. It should be noted that at the end of the user's data analysis exercise, the new study object 650 is transformed to a cluster of dynamic objects—or aggregates of information associated with a study event(s). The new study object 650 and all of its associated objects and information may be accessible and reproducible by the user or a different user in the future. The study object of the present disclosure presents, therefore, a cluster of objects that provided a durable visual context of historical, present, and ongoing analyses.

Quick View Capability Analysis

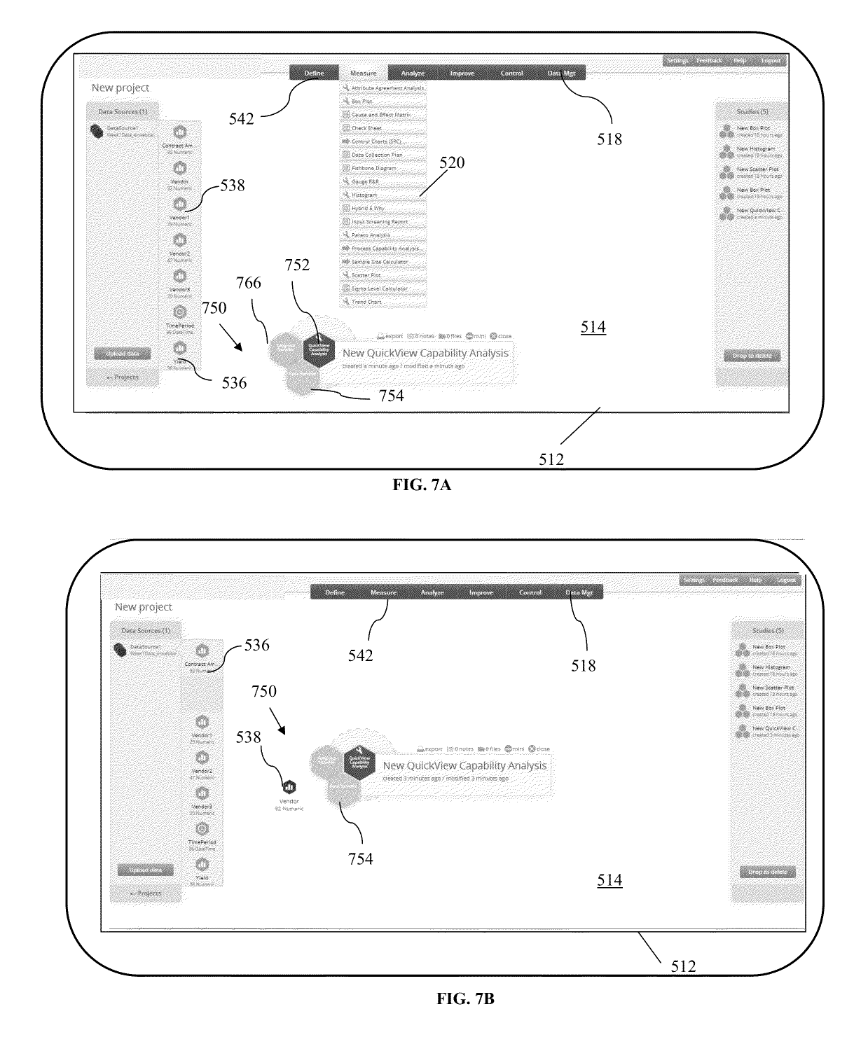

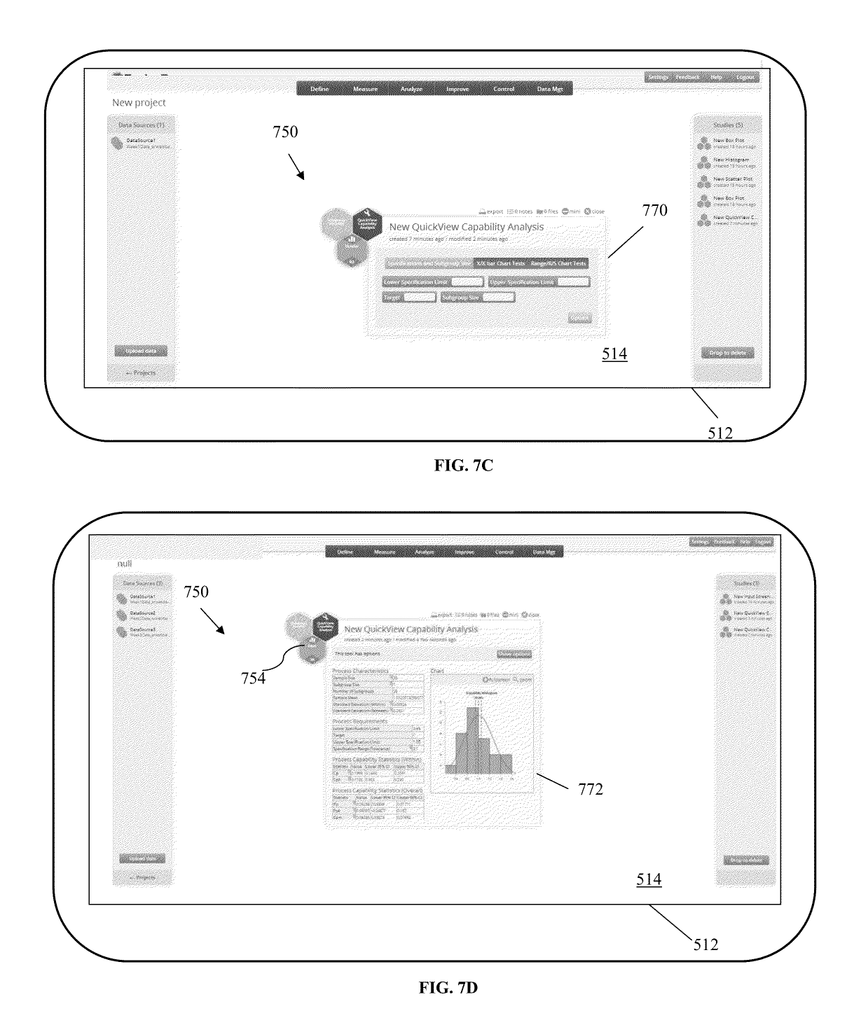

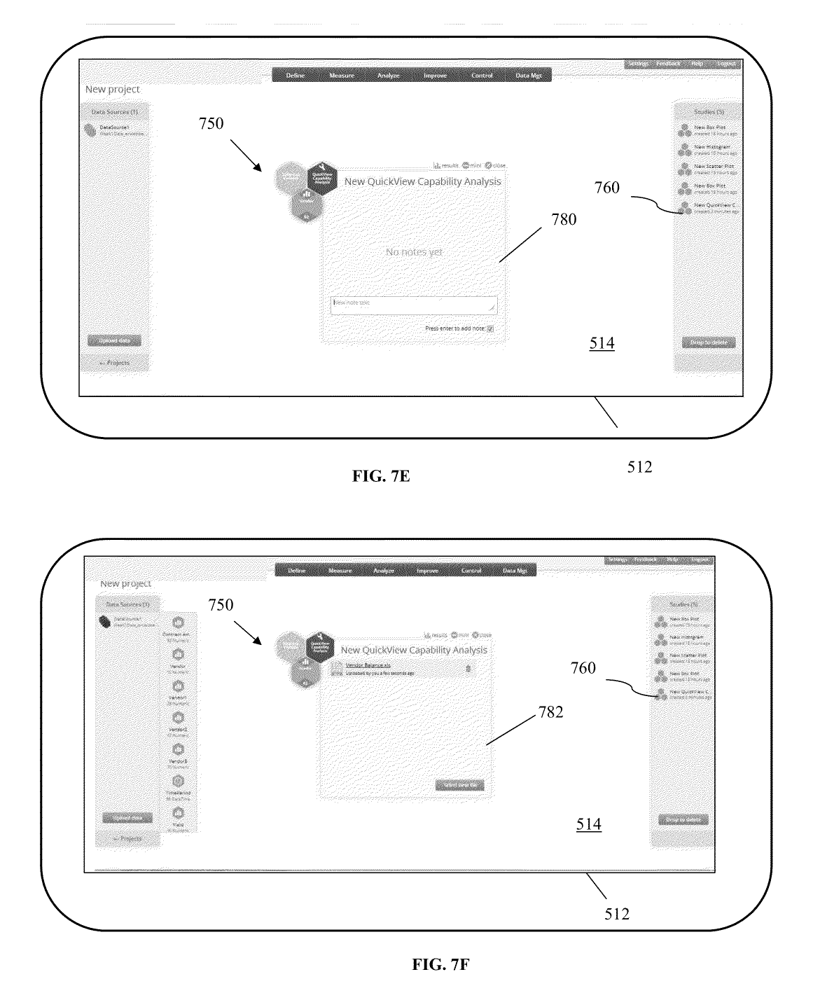

FIGS. 7A-7F depict another user interface environments suitable for a data analytical software application and incorporating various advantageous user interface elements and techniques, according to the disclosure. The user interface 512 shown illustrates again the object-oriented approach followed in the system and method. In particular, these examples illustrate the advantage gained in utilizing user interface objects with visual attributes to represent data and as a vehicle to link or translate data between objects or from one location to another in a workspace 514 of the user interface 512, and also at different points in time for a project or different users.

In this example, the user evaluates a process improvement effort by conducting a process capability analysis. The user finds and enables the Measure phase tab 542 on the Task Menu 518. From the pull-down Tool Bar 520, the user selects a Quick View Capability Analysis Tool. As readily understood in the art, this type of analysis is used to evaluate whether a process is statistically able to meet output requirements. The analysis typically involves a set of calculations on target data. As in the previous example, presentation of the data analysis tool in the workspace 514 establishes a new Study without any data file or data objects being associated with the Study. A new study object 750 appears in the workspace 514, with text attributes that indicate a numeric data variables field and a numeric subgroup field. Viewing the study object 750 in conjunction with the Data Variables Panel 536 to the left gives the user directions on completing the desired data analysis, particularly in selecting data variables for entry into the data variables field object 754.

The study object 750 is provided in the familiar honeycomb icon that appears to be built by complementary hexagon objects on a light colored circular background 758. The objects are differentiated by name, color, and position. Appropriately, the tool or operation object 752 is positioned at the center or hub of the study object 750. The tool object 752 is also further distinguished by a wrench icon. The light circular background 750 on which the objects are situated has a broken or dashed perimeter (dashed) to convey incompletion. By prompting the field objects, the user gets a useful tip on selecting data variables. The study object 750 suggests to the user what data variable objects may match the data variables field 754 and subgroup variables objects 766 in the study objects. As shown in FIG. 7B, the user selects and drags a data variables object 738 from the Data Variables Panel 536 toward the data variables field object 754.

On engagement of data variables object 738 with study object 750, a window 770 associated with the Study and with the study object 750 is outputted. The window 770 functions as a workpad that provides the data analysis tools available. The workpad 770 also uses color coordination to show which object is associated with the displayed tools FIG. 7D provides results in another window 772 using a first data variables object, which include charts and data summaries. It should be noted also that the output will automatically change when the first data variable FIG. 7D also shows that the results of the study are automatically changed when the data variables object 754 entered is replaced by another.

Each of FIGS. 7E and 7F illustrates yet another advantageous feature of the user interface 714. In FIG. 7E, study object 750 is modified to include a window 780 in which text notes may be entered for the Study. The text notes window 780 becomes yet another object piece in the cluster of objects (and information) that is (and associated with) the study object 750. As with the other objects, the text notes window 780 is reproducible on enablement of a corresponding stored study object 700. The text notes window 780 provides user-added or user-associated information that may be particularly helpful to a second user working with or after the first user.

In FIG. 7F, the study object 750 is modified to include a window 782 that contains a link to a file or other artifact identified to the study that then becomes associated with the Study. Window 782, and the artifact within window 782, is yet another object element added (by the user in this case) to the cluster of objects that make up the study object 750. In some applications, the file may be a report with detailed interpretations or conclusions applicable to the data analysis output or the project. The file may be intended for the user's future use or use by another user or third party. In further embodiments, the uploaded or uploadable artifacts can be image files, videos, or documents, among other things. Such user-added information provides further context and helps users comprehend the practical significance of any conclusions reached from the study output—especially in a shared environment where multiple users may participate in the analysis and contribute to the critical thinking. As again shown in these examples, the visual object-oriented approach facilitates communication and transitions among groups who are working on a project, sharing data, and/or jointly performing the analytical work.

Project Mapping

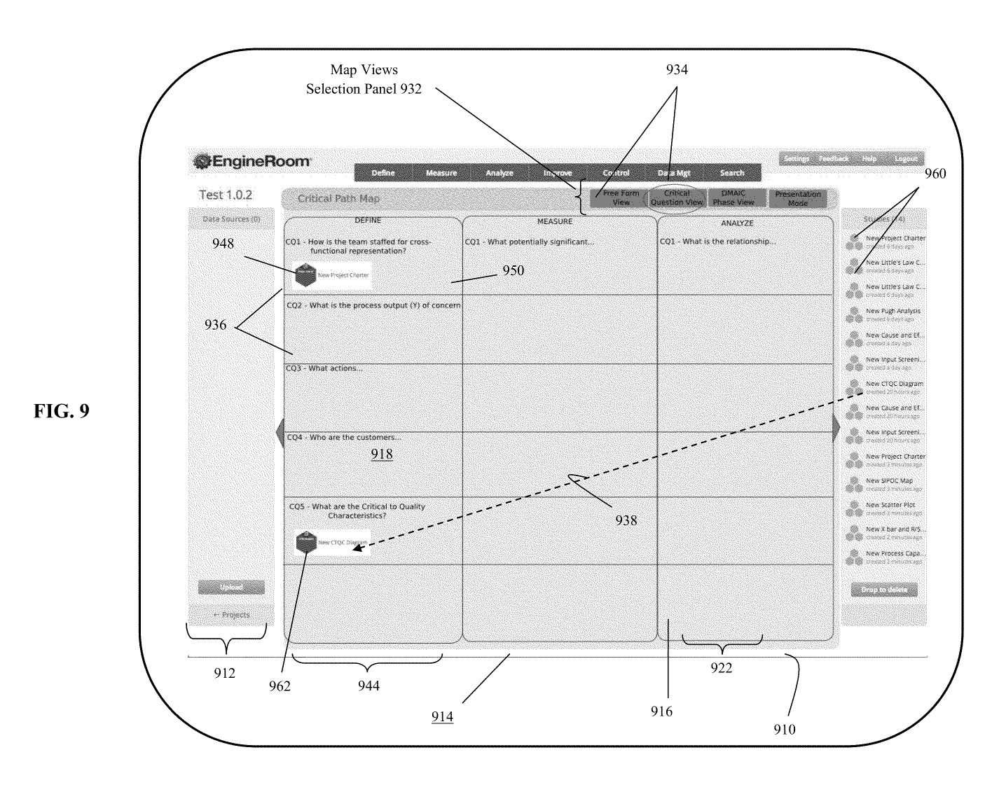

FIGS. 9-13 illustrate a singular aspect of the present disclosure, including a system and method for capturing and/or organizing the steps or path of deductive reasoning used in underlying project processes. For illustration, the system and method may be readily described in the context of, and as an extension of, the data analysis software application and processes previously described in respect to FIGS. 3-7. FIGS. 9-13 provide graphical user interfaces generated through use of the software application, and employing some of the same features and elements already described herein. The graphical user interfaces are introduced, however, under a different and particularly advantageous operational mode of software application, which preferably employs further embodiments of the graphical user interfaces.

More particularly, the systems and methods described in respect to FIGS. 9-13 utilize the previously described system and method for creating a statistical study. Specific employment is made of the study object element, such as the study object 650 and saved study object 660 in FIG. 6B, and related graphical user interfaces. As described previously, the study object 650 brings together the source data, the analysis tool, and graphical and textual results content together into a single graphical element (the “study”). In the engaged or open mode of FIG. 6B, the study object 650 includes or incorporates graphical object elements signifying the data analysis function, stored data set, and graphical element output, among other graphical elements. The graphical element output is typically a graph, chart, or table presenting the analytical results of the data analysis function. For positioning or storing in the studies panel 522, the study object 650 is reduced to a more streamlined graphical study object 660, shedding many of the individual graphical elements previously incorporated. The stored study object 660 may be referred to as being placed in stored, closed, or reduced mode. In any case, the study object provides a consolidated micro view of a particular thought process as it relates to a single study.

In a further aspect, the system and method of the disclosure utilize graphical user interface elements to present a macro view of the underlying analytical processes of a project, which may be composed of a series or group of studies, among other things. In specific embodiments, the subject project may include tasks and activities directly related to the studies or prompting or arising from the studies, including critical questions and answer tasks. In one example, a collection of studies providing individual steps in the analysis process are presented in a relationship or mutually logical view and form a graphical map of the analytical process. In a related method, a user employs a graphical user interface to move or arrange object elements about a canvas depicting a contextual background relevant to the process. Such a graphical representation of study object elements and their relationships is referred to herein as project activity mapping, critical project mapping or simply, project mapping. Such representation may also be described as critical thought process mapping (CTM) or critical path mapping (CPM). Recalling that the studies relate the input, analysis tool, and output of an inquiry into a single graphical element, the project map now takes those separate graphical study elements and combines them, preferably through a drag and drop interface or automatic recall of studies sequence and map placement, into a single map that describes the analytical thought process behind the project or a portion of a project.

In one respect, the single study object may be considered as also providing the described macro view of the underlying process. It may be regarded as a special or basic case that involves a single or limited number of analytical processes. The selection of data and data analysis function and initiation of the function to generate a graphical element output can reveal the underlying thought process behind the project. Most applications will, of course, involve multiple studies and study objects in presenting the desired macro view and with greater effect.

Traditional analysis software does not provide an embedded method of documenting the deductive logic employed to solve a problem being studied (i.e., the project). Discretion is given to the user to create some type of file and folder naming convention to categorize the underlying work. The transfer of the results of the work then becomes a manual process of copying and pasting the various pieces of that work into a second piece of software that tracks or presents the project. A best case outcome of this style of process is that a diligent user spends extra time moving and synchronizing their analysis process, inputs, and outputs with these external pieces of software. It is also possible, however, that the user loses track of analyses that have been performed and the current state of the output.

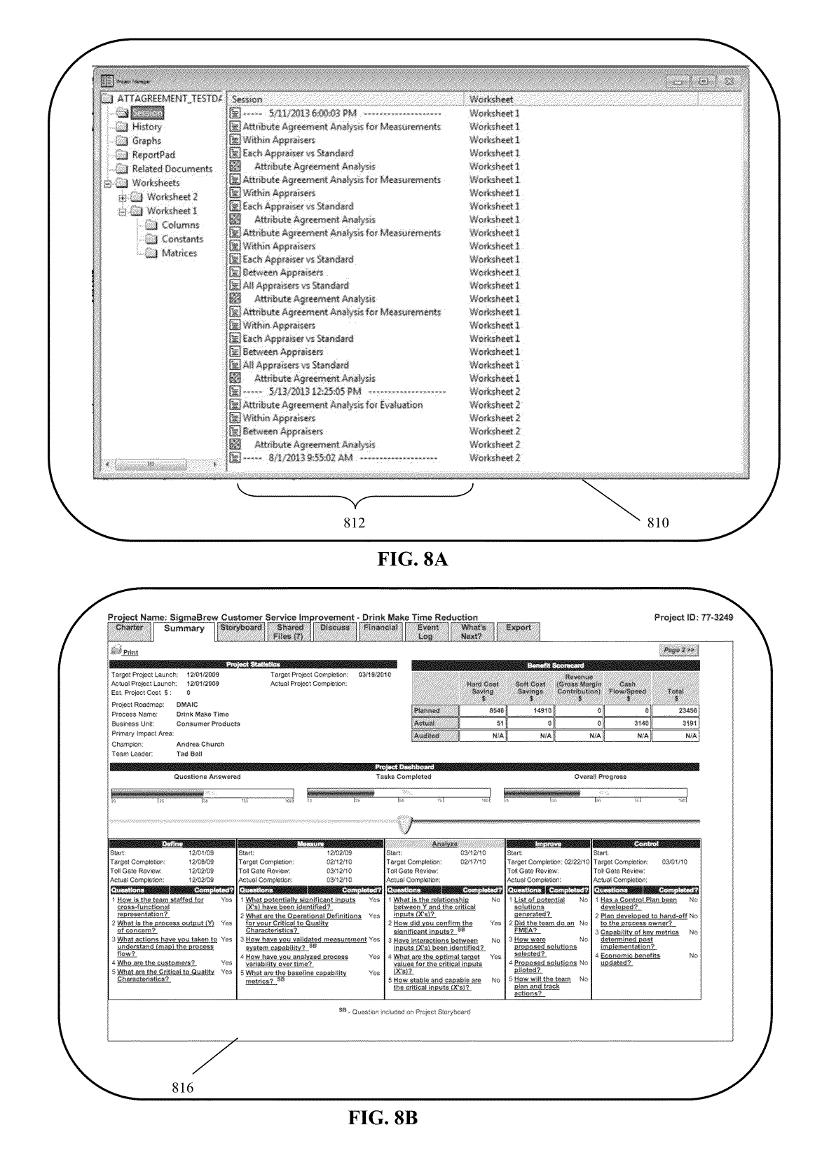

FIG. 8A depicts a worksheet 810 (a computer-implemented user interface) used or employed for project data and analysis tracking and organization. Note that project information files 812, including data (Worksheets), output (Graphs, Session), and other project information, is maintained in list form by type of output. No mechanism is provided for organizing the information into a coherent story relating data, analysis, and output together in any relationship flow. Further, there is no readily observable relationship or logical flow between the files or their order, except that a chronological order may be inferred or the list entries may be automatically or manually sorted by date, alphabetical, or other individual attribute of the entries. FIG. 8B depicts user interface 816 presenting a typical Lean Six Sigma project tracking software view of a project. While this software provides a structure for recording progress through the analytical steps of the project, data entry is manual and separate from the actual analysis. There is no linking of the fundamental components of input, analysis, and output in a single, graphical element.

In accordance with the present disclosure, the software application is further configured to operate in a map viewing operational mode and/or to generate a map view of the project. A graphical user interface is also provided in which, or by which, the study object elements or equal (the micro information) may be relatively positioned to present a critical thought or critical path map. Alternatively, the graphical user interface may be used to move or integrate a study object element or equal directly onto a project map.

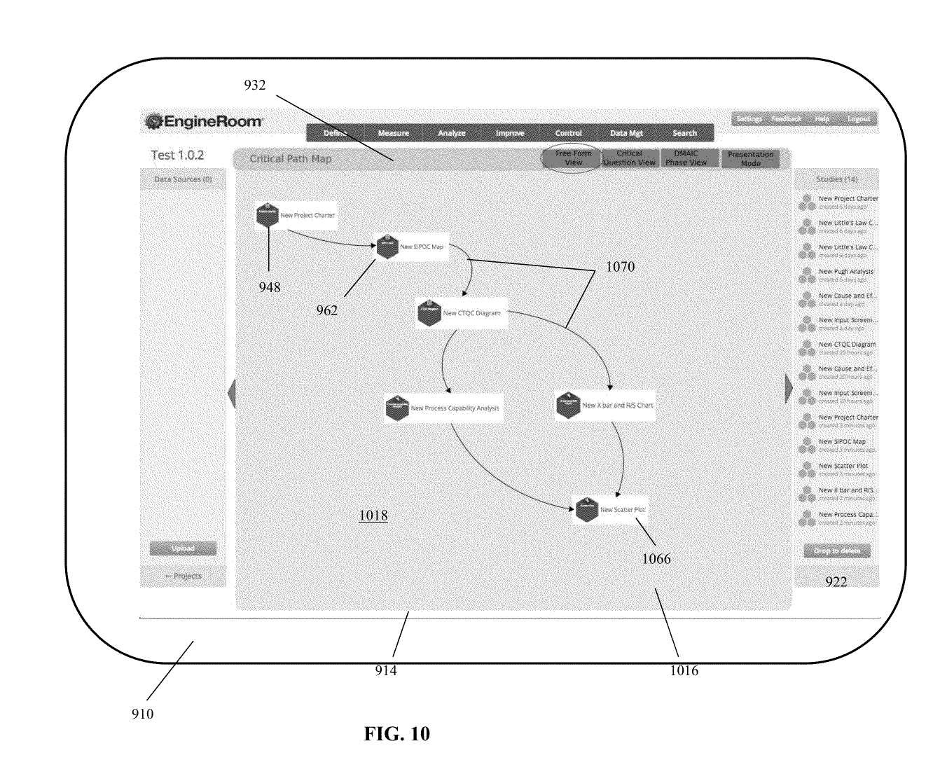

FIGS. 9 and 10 show alternative views of a graphical user interface 910 embodying a critical thought map, or a method for critical thought mapping, according to the disclosure. More specifically, the project map is a critical question map (from which the critical thought process is inferred). As with previously described embodiments, the user interface 910 includes a data source panel 912, a studies panel 922, and a relatively large workspace 914 positioned therebetween. The data source panel 912 and studies panel 922 store controller movable object elements representing historical data and studies. The studies panel 922 in this instance contains a full slate of stored study objects 960, including such representative studies as a Pugh analysis, a scatter plot, a project charter, and a CTQC diagram. In this stored or closed mode, the study object 960 contains graphical features that are indicative or signify the related process or study type from which it originates. The stored study object 960 does not, however, include the individual object elements normally presented in the open or engaged mode, such as the results of the analysis.

In most applications, the workspace 914 provides a canvas onto which a contextual background is projected and then object elements representing analytical elements may be moved about and/or arranged in preferred mutual juxtaposition. In various embodiments, the contextual background is provided by a map overlay or underlay 916 revealing a framework on which analytical tasks progress in the project. Because the underlay designates the logical association between its different regions or parts, two study objects positioned on different region or parts of the underlay are automatically mutually associated indirectly. The underlay is, in one respect a fixed or permanent map, while the study objects are dynamic activities the occurrence of which may be tied to unique positions on the map. Thus, the positioning or identification of multiple activities or occurrences to the points or regions of the map may be described as the mapping of these activities or occurrences. Further, a map having such activities indicated thereon may be described as a project. Thus, with the study object elements presented thereon, the canvas transforms to a preferably user-interactive critical thought map or project map 918.

The graphical user interface 910 further includes a map view panel 932 containing various selection bars 934 identified to alternate map views. In this embodiment, four map view selections are provided: a free form view, a critical question view, a DMAIC phase view, and a presentation view or mode. The map view shown prompted in FIG. 9 is a critical question view, which presents a critical question worksheet as a logic guide to project participants. A series of questions are provided in question boxes 936 and presented to the user in pre-determined order and phase grouping (of boxes 936)(e.g. Define, Analyze, and Measure). The phase groupings are projected on the map 918 as multiple columns 944 arranged side-by-side, and each containing multiple question boxes 936. The order or logic of the columns 944 and the question boxes 936 are predetermined. The questions are designed to prompt the user and, as applicable and necessary, initiate analytical activity in the form of studies. Thus, the positioning of study objects 948 in the appropriate question box 936 which prompted the study provides a critical thought process map (CTM) or critical question map (CQM).

In the project tracked by the user interface 910 in FIG. 9, the series of questions have progressed under the Define phase. The map 918 shows that the critical question, “How is the team staffed for cross-sectional presentation?”, initiated a run of a “New Project Charter” study. This is indicated by the positioning of the appropriate “New Project Charter” Study object element 948 in the first critical question box 950. Further down in the progression of critical questions under the Define category, another study was conducted. Specifically, a new CTQC diagram study was prompted by the critical question, “What are the Critical Quality Characteristics?” As illustrated in the map view of FIG. 9, study object 962 is moved (as indicated by the dash lines) from the side panel 922 to CQ5 box 938. Such positioning may be accomplished by drag and drop techniques, as previously described. Once a study object is positioned on the map, the user can engage or prompt the study object to open it and view the underlying information, e.g., data and results of the underlying study. The stored study object may be described as being opened or engaged to place it in the engaged mode corresponding to the underlying engaged study object.

Referring again to the map view of FIG. 9, study objects 948 and 962 are graphically associated by way of the CPM map or worksheet. For example, both study objects 948, 962 are associated to a project, and to a common Define Phase. Under the Define Phase Region 944, the study objects 948, 962 are mutually associated through the order of the critical question boxes 936 and the logic behind such order.

FIG. 10 illustrates a transformation of the graphical user interface 910, according to the present disclosure (and wherein like elements are indicated by like reference numerals). As indicated on a map view panel 932 above a central workspace 914, the user has switched to a free form map view and a free form map 1018 occupies the workspace. The underlay in this case is provided by a blank canvas, which, in some applications, may be regarded as a temporal map wherein time progresses in one direction (i.e., in the horizontal or x-direction). In other applications, including the totally unstructured free form view, the blank canvas provides a spatial map, where the relative positioning of the study objects reveals their logical relationships. The free form map 1018 represents the logical relationship among selected study objects by way of their spatial relationship and with the aid of graphical segments or directional arrows 1070. In the illustrated embodiment, the spatial relationship is indicative of the sequential, analytical process (i.e., logic flow). In this simplified example, the map shows analysis for the same project commencing with creation of a new project charter, as indicated by the leftmost positioning of a study object 948 for a new project charter. Later in the string of study objects, study object 962 indicates creation of a new CTQC and diagram (as before). The last bit of analysis in this example is represented by the same study object 948 corresponding to generation of a scatter plot. Thus, the map 1018 indicates that to arrive at the New Scatter Plot Study, two paths bridge that study with the new CTQC diagram.

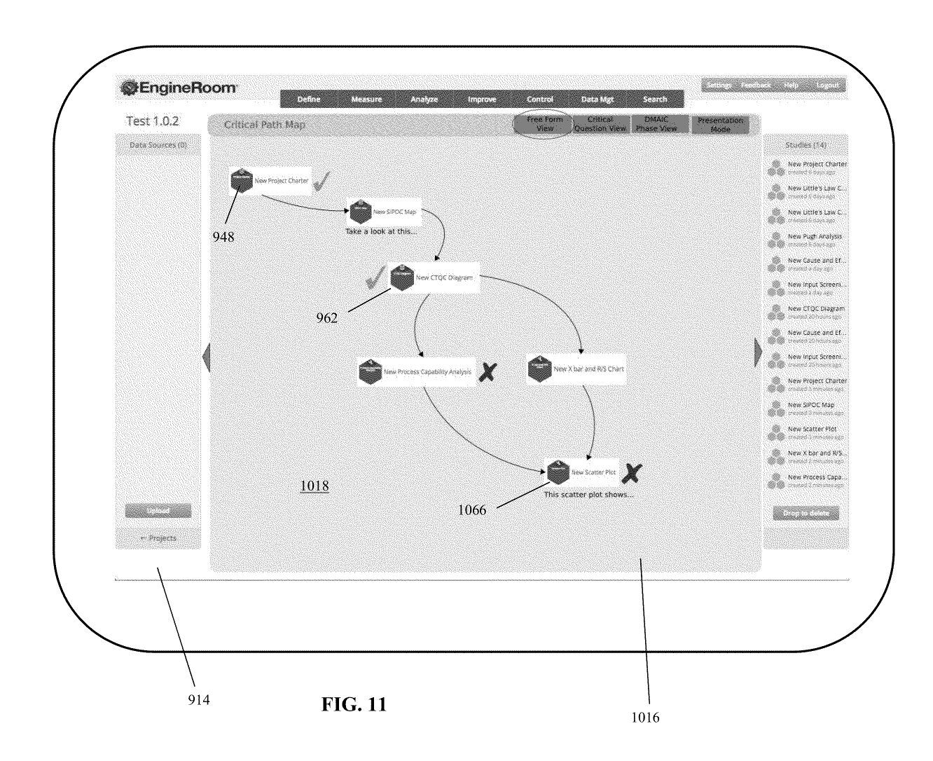

In FIG. 11, the free form map of FIG. 10 is shown modified with annotations made by user. The user has, in this set of studies, discounted the use of two of the studies. This is indicated by placement of a red “X” next to the study object instead of a green check. Note that other annotations descriptive of the analysis, or providing insight, may be provided by the user for future references or for incoming other project participants and team members

In further embodiments, a user may elect to drag only selected portions of a study onto the project map. Using this method, the user might select key tables or charts of output that are highly relevant, without including the entire study. The user can either drag the entire study into the project, or just the relevant pieces of the study needed to document that point in the critical thought process. Any portion of the study dragged into the project links back to the original complete full study.

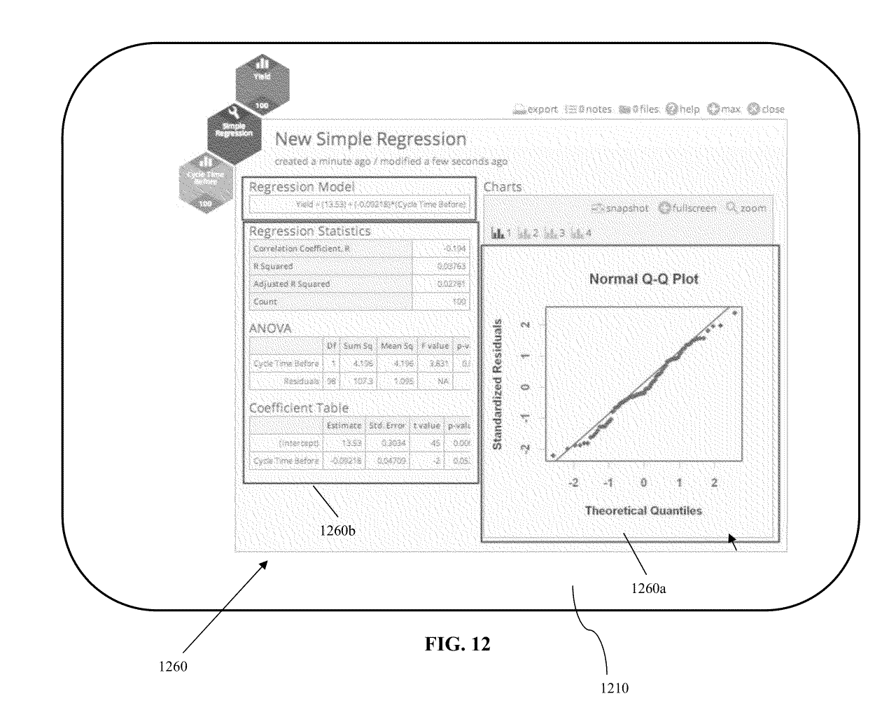

An example of the study components available to drag into the map are included in FIG. 12, and highlighted. A user interface 1210 represents a simple regression study in open form—with underlying tools, data, and results presented. The user has shown to select only a normal Q-Q plot 1260a and regression statistics 1260b for display.

In some applications, the selection of a map view may generate a project map with the stored study objects already positioned thereon. In further applications, the user may exit from one map view and select another map view. In this exemplary case, the second map view may include many, if not all, of the same study objects presented in a different logic view. Such map views may be automatically and gradually built as project participants engage in analytical activities and progress through a project. Such a progressing project map may be stored in hidden view, but preferably, readily viewable by navigating the user interface.

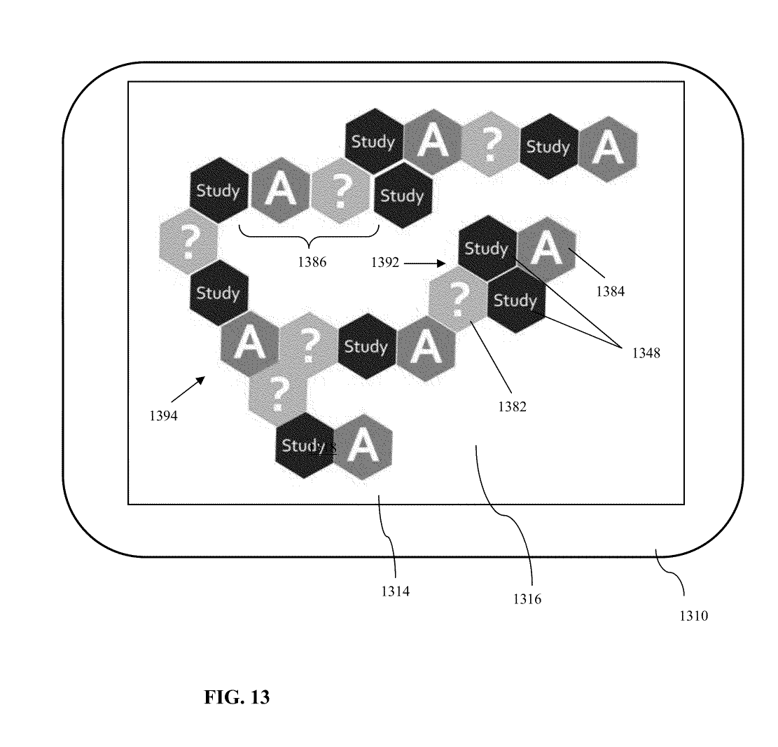

FIG. 13 depicts yet another graphical user interface 1310 presenting a critical thought process or project map 1318, according to the present disclosure. The user interface 1314 may be described as projecting another user-selected map view that employs various features of previously described map views. As before, multiple study objects 1348 in stored mode are preferably positioned in a workspace 1314 in mutual association to present the project map 1318. An underlay 1316 is provided as blank space and, thus, the study objects 1348 are preferably further graphically associated (beyond mutual juxtaposition on the underlay 1316). In this embodiment, the study objects 1348 are physically associated indirectly and contiguously by serial graphical object elements 1382, 1384 representing critical questions and answers, respectively. Thus, the map 1318 itself is projected as a chain of study objects 1348, critical question objects 1382, and answer objects 1384. This “molecular chain” view replaces map views of the type depicted in FIG. 10, wherein line segments (with directional arrows) 1070 graphically connect study objects. The line segments 1070 are replaced by graphical segments 1386 of serially connected question objects and answer objects. As with the line segments, these Question-Answer graphical segments 1386 provide logic information as conveyed by the spatial relationship, including perhaps directional information, between study objects 1348. The graphical segments 1386 provide additional substantive information on the segments themselves, particularly the types of questions and answers between and logically connecting the study objects 1348. The exemplary map view on FIG. 13 omits more specific question and answer information as a matter of convenience and present illustration, however.

The map view of FIG. 13 omits the context and content type of underlay used in the map view of FIG. 9, for example, opting instead for graphical segments and spatial relationships conveying the mutual association between study objects. It should be noted, however, that the “molecular chain” map view presents a completely contiguous connection or relationship between study objects, which is in contrast to the spatial relationship connections in map views employing an underlay.

In one aspect of this embodiment, the use of hexagon-shaped object elements allow the user to build a “critical thinking molecule”, which provides more than just a single direct or linear connective path between objects. The exemplary map 1318 illustrates, for example, a question requiring two studies to answer and an answer eliciting multiple questions. These two types of segments in a critical though process or project are graphically presented in the map 1316 of FIG. 13 (see segments 1392 and 1394, respectively).

As with other map views, each of the study objects 1348 is controller engageable to project and display its contents (i.e., in open or engaged mode). Similarly, each of the Critical Question objects 1382 and each of the Answer objects 1384 may be controller engageable to reveal information on the underlying question or answer. Further yet, each side or projection of hexagon may be separately engageable to highlight or reveal that segment of the process. For example, each side of an answer object that elicits two subsequent questions may be prompted to highlight and reveal further information on the subsequent segment of question-study-answer. In such case, the highlighted objects may be presented in open or engaged mode to reveal the detail information.

In preferred applications, a user interface will be provided that allows for transformation of the “molecular chain” view of FIG. 13 into one of the other previously described map views. For example, the “molecular chain” map 1318 may be readily transferred into a critical question worksheet view, similar to that depicted in FIG. 9. The “molecular chain” map 1318 may also be readily transferred into an absolutely free form map, as illustrated in FIG. 10. In such a transformation, critical question and answer objects 1392, 1394 would be replaced with line segments. An appropriate map view selection panel positioned above the worksheet 1316 would allow the user selection of these additional map views, and interoperability between maps for the user.

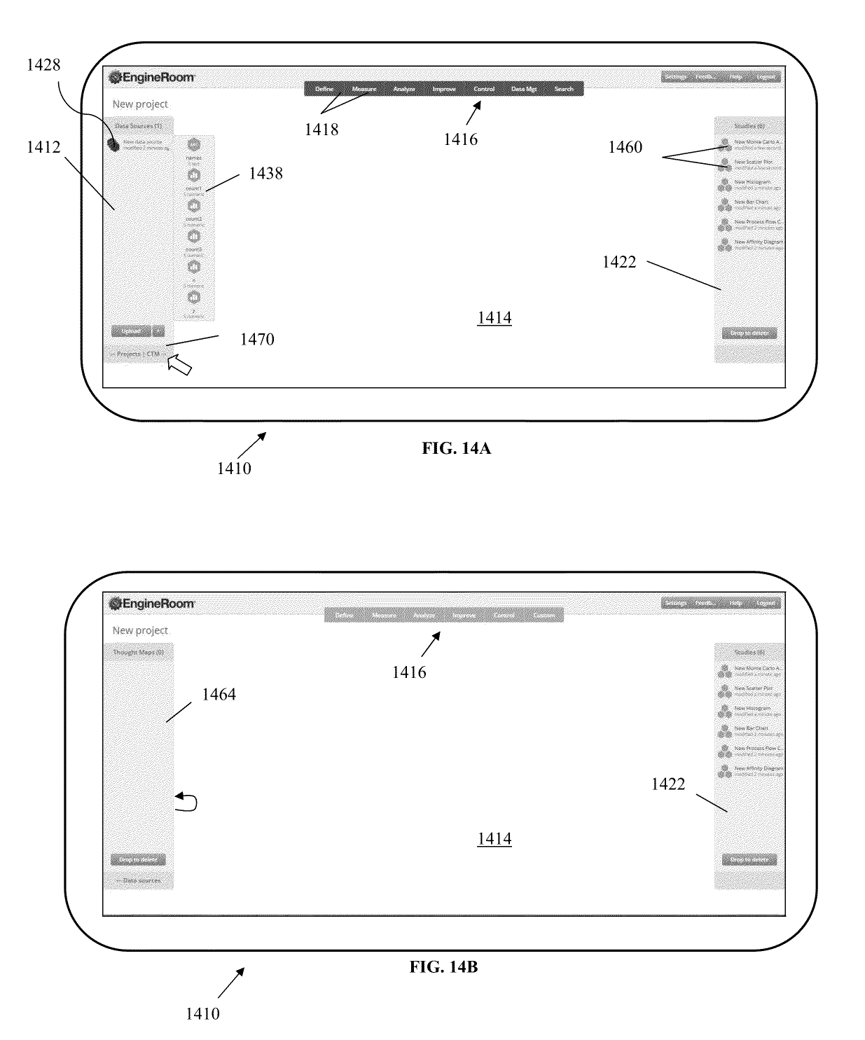

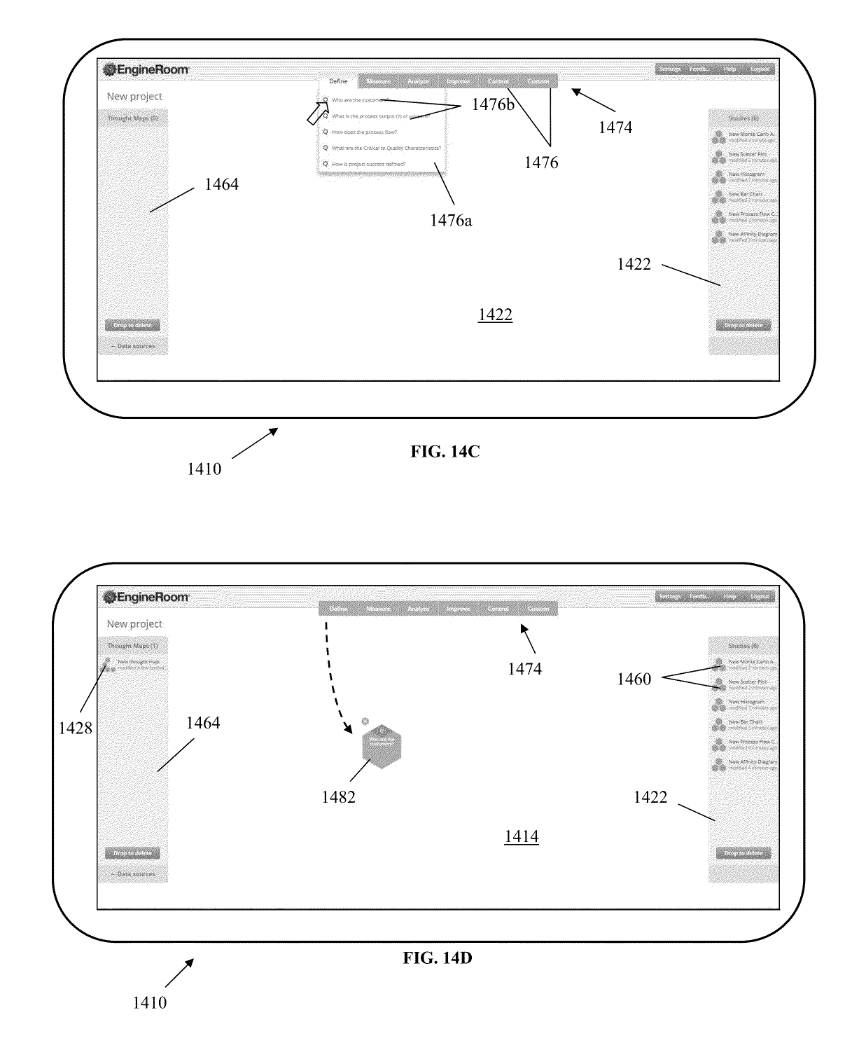

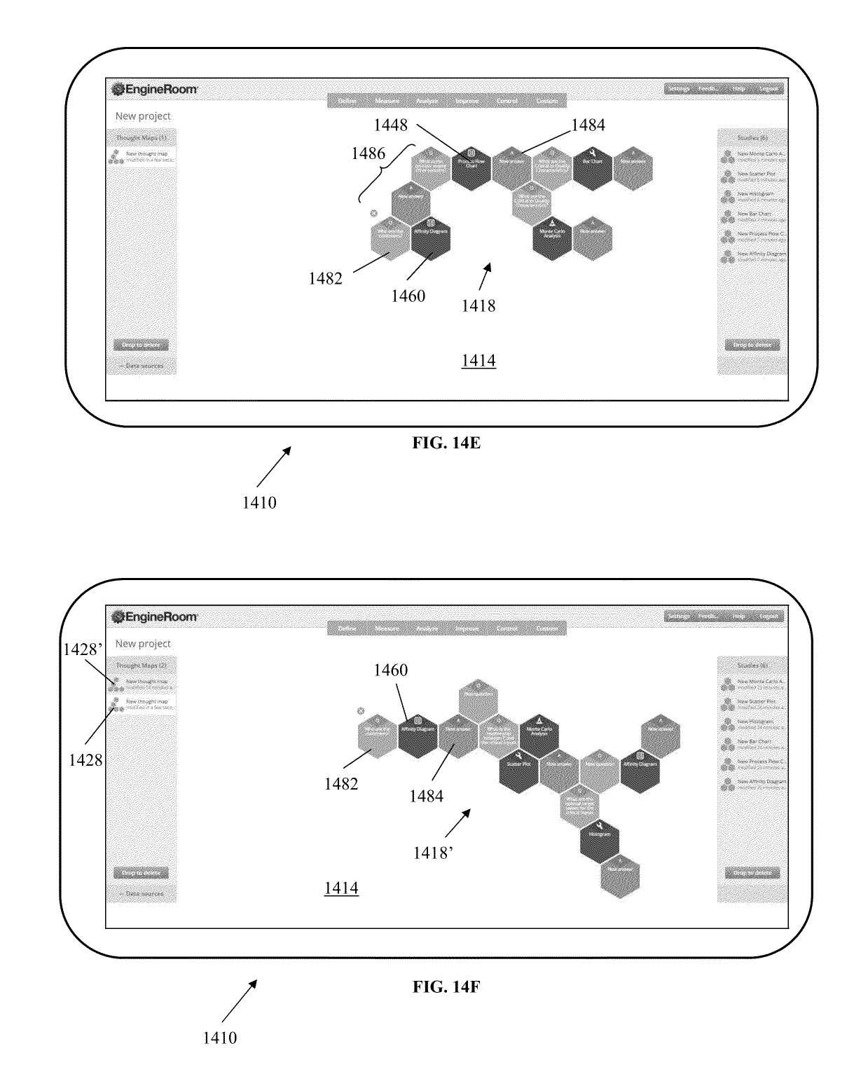

FIGS. 14A-14F depict various stages of a further, exemplary computer-user graphical user interface 1410 in generating and presenting a project process map 1418 (wherein like reference numerals are used to indicate like elements) according to an alternative embodiment. The user interface 1410 presents a project map 1418 in critical question views, and more specifically, in the same “critical thinking molecule” or chain form as described above in respect to FIG. 13. FIGS. 14A-14F also reflect a computer-implemented method of generating a process map identified to a project. As with previously-described user interfaces according to the disclosure, the exemplary computer-user interfaces employ graphical object elements and their graphical relationships to convey and reflect the progression of a project in terms of the analytical processes and the objects of such processes, which define the project. The user interfaces may also be used to describe, or present to an audience, the historical processes that define a project. Alternatively, the user interfaces may be employed by the author to track, monitor, or convey the project in progress. In this way, the project maps are employed as another tool used in advancing the project to completion.

Referring first to FIG. 14A, the user interface 1410 presents a centrally located workspace 1414 bordered by a data source panel 1412 and a studies panel 1422 on respective left and right sides of the workspace 1414. The user interface 1410 incorporates many of the features and functionalities described above in respect to FIGS. 5-7 and 9-11. The user interface 1410 displayed may be described as being in project mode and identifies a New Project with a set of associated stored study objects 1460 (maintained in the studies panel 1422) and a data source object 1428 (maintained in the data source panel 1412). Along the top of the workspace 1414, a DMAIC Task Menu bar 1416 consists of several tiles 1418 each of which may be engaged by a controller to activate and reveal a pull-down menu, as previously described.

In project mode, a CTM tab 1470 is provided on the bottom of the data source panel 1412. In FIG. 14A, a controller pointer (arrow) is shown reaching the CTM tab 1470, so as to engage the tab 1470 and reveal a Critical Though Map screen as shown in FIG. 14B. A Maps Panel 1464 now replaces the Data Sources Panel 1412. The CTM user interface 1410 retains the Studies Panel 1422 to the right of the workspace 1414, however. The user interface 1410 maybe described as being engaged in Map View or Mapping mode.

The Map Panel 1464 in FIG. 14B is shown empty, which signifies that no critical though maps have been saved for the active project. The user interface 1410 provides, however, a new Critical Question (CQ) Menu bar 1474 above the workspace 1414, the use of which may identify a Thought Map to the project. The CQ Menu 1474 presents several pull-down menu tiles 1476, including five menus identified to the DMAIC stages and a “Custom” menu. A pull-down menu 1476a is available for each DMAIC stage tile and presents the various critical questions associated with that stage. In FIG. 14C, the Define Menu tile 1476 is highlighted by the controller and clicked to reveal a menu 1476a of five critical thought questions 1476b for selection. Each critical thought question 1476b may be engaged by the control pointer and then dragged onto the worksheet. FIG. 14 D illustrates the result of dragging (as illustrated by broken path arrow) a first critical thought question onto the worksheet 1414 and dropping it: a hexagon-shaped Critical Thought Question object 1482 is located in the worksheet 1414.

Once the Question object 1482 is located on the worksheet 1414, a stored study object 1460 may be selected from the Studies panel and moved to engage the Question object 1482. This creates a short Project Map or the beginning of a larger one reflected in a “molecule chain” configuration. At this point, the user can access the custom tile in the Task Menu Bar 1416 which reveals a “New Question”: and “New Answer” selections. Selecting the “Answer” option activates an answer object 1484 that the user can drag onto the worksheet 1414 and logically locate adjacent and in engagement with the Question object 1482 (to which it is associated). Alternatively, the “Answer” option may be simply clicked and the Answer object 1484 will appear adjacent the last or active Study object (or other graphical object element). As described previously and reflected by the map view of FIG. 13, the serial or linear combinations of question objects, study objects and answer objects (e.g., graphical segments 1486) presents a project map revealing the critical thought or analytical process underlying the project. Multiple combinations of graphical object elements presented in logical connectivity, as described above, generates a critical thought map, such as the map 1418 in FIG. 14E. Accordingly, the process described above may be used to recreate, or customize the process map for the identified project.

In an alternative application, the user interface 1414 of FIGS. 14C-14D is used in advancement of the project (e.g., in critical question-evidence-answers progression). The questions presented by the pull-down menus 1476a are used as a guideline or framework. The user may be revert back (and forth) to project mode (see e.g., FIG. 14A) to initiate the appropriate data gathering or data analysis functions, and generate stored study objects 1460 for retention in panel 1422. In the CTM mode, the user can update the project map 1418 by engaging the new Study Object(s) 1460 with the Question object 1482 (which prompted the Study). The user can also prompt an “Answer” object 1484 by accessing the “Answer” option under the Custom pull-down menu 1476a and locate an Answer object 1484 adjacent the active (or newly engaged) Study Object(s) 1482. If the new “Answer” prompts or warrants a new Question, the user can access Menu Bar 1474 once again and consider engaging the next critical question statement under the appropriate DMAIC phase.

Preferably, the Custom pull-down menu 1476a will provide both an Answer and a New Question option. By selecting and then dragging (or double-clicking) New Question statement, a new Question object 1482 is engaged with the pending or logically available Study Objects 1460 (i.e., locations on the Project Map 1418 for a Question object adjacent a Study Object). As with a new Answer object, the New Question object 1482 may be engaged by a controller to allow entry of the custom question.

FIG. 14F provides the same user interface 1410 as illustrated in FIG. 14E, with a second critical thought map 1418′ displayed. The map 1418′ reflects a different project thought process from the map in FIG. 14F. A critical thought map object 1428′ corresponding to the new map 1428′ is maintained in the thought maps panel 1464 and, as shown, highlighted to indicate active status. Another Map object 1428 corresponding to the map 1418 discussed above in respect to FIG. 14E is also stored in the map panel 1464, but not highlighted. This first map object 1418 may be engaged by a controller to activate and display again, on the workspace 1414.

Referring to the exemplary project maps 1418, 1418′ in FIGS. 14E and 14F, a user may employ the user interface to present or convey project related matters to an audience. Firstly, the maps 1418, 1418′ provides the audience context as specific task or information are explained. The maps 1418, 1418′ can also provide the guideline or frame by which the user describes the project. Each of the object elements that make up the project map 1418, 1418′ may be engaged to highlight or reveal (hidden) information associated with the pending or pending object element. For example, a stored study object may be engaged to reveal details of the process or tasks taken to answer a question, e.g., a chart or analysis. In further embodiments, the object elements may be programmed to be revealed in specific sequence and present a progression of information.

The foregoing description of exemplary embodiments is not intended to limit or restrict the scope or applicability of described systems, methods, and user interfaces. For example, the description focused on a particular type of software application, but such descriptions were provided for illustration and to give context to the described elements, methods, and procedures. It will be apparent to one skilled in the relevant art that many of these elements, methods, and procedures will also be applicable when integrated with or used in other environments. Specifically, many of the user interface features and techniques described in respect to FIGS. 3-13 may be used in conjunction with many other types of software applications, analytical methods, or computing environments.

1. A computer-implemented method of process mapping on a graphical user interface of a computer display, said computer-implemented method comprising:
presenting a graphical user interface on a computer display of a computing apparatus having a controller, the graphical user interface containing a plurality of graphical objects each controllable by the controller, including a tool object associated with a data analysis function and at least one data object associated with at least one stored data set partly;
upon selection of a tool object and at least one data object, initiating the data analysis function, whereby the at least one stored data set are input variables to the data analysis function and a graphical element is displayable on the user interface as output (graphical element output) and generating a corresponding study object identified to a project, the initiated data analysis function, and the graphical element output;
in respect to each of one or more sets of a tool object and a data object associated with a stored data set, repeating said initiating the data analysis function and generating a corresponding study object to generate another study object commonly identified to the project; and
displaying a plurality of said study objects identified to said project on the user interface in logical relation, thereby generating a process map for the project.

2. The method of claim 1, further comprising:
after each initiating the data analysis function, generating the study object in storage mode (stored study object), the stored study object being further engageable to initiate display of, at least, the graphical element output, wherein said displaying study objects to generate the process map displays said stored study objects.

3. The method of claim 2, wherein the user interface includes a study object storage region, and wherein said each said generating a stored study object includes positioning the stored study object in the study object storage region, each of the stored study objects being retrievable therefrom for positioning in a second region of the graphical user interface to generate the process map.

4. The method of claim 3, wherein the user interface includes a workspace and wherein said displaying stored study objects includes retrieving each stored study object from the study object storage region and positioning the stored study object in the workspace.

5. The method of claim 2, further comprising:
positioning said plurality of stored study objects on the user interface in mutual graphical association, whereby a relative arrangement of the study objects presents a multi-study process map.

6. The method of claim 5, wherein the study objects are mutually graphically associated by graphical segments connecting the stored study objects.

7. The method of claim 6, wherein a string of stored study objects connected by graphical segments indicate a chronological project flow.

8. The method of claim 6, wherein the graphical segments are line segments indicating logic direction.

9. The method of claim 6, wherein the graphical segments include graphical object elements that are controller engageable to display additional graphical elements associated with the graphical object element.

10. The method of claim 5, wherein the study objects are mutually graphically associated by being mutually presented on a common graphical underlay.

11. The method of claim 10, wherein the graphical underlay includes graphical elements identified to stages of a project, each of the study objects being identified to said graphical elements.

12. The method of claim 1, wherein the study objects of the process map includes identification of the data analysis function associated therewith.

13. The method of claim 1, further comprising:
prior to initiating the data analysis function, establishing a study object upon selection of the tool object, wherein initiating the data analysis function includes moving at least one of the data objects and study object from one location on the user interface to another location contacting the other of the data object and study object.

14. The method of claim 13, wherein the study object includes a data variables field having a shape that matches a shape of the data object, such that the data object is moved substantially into the data variables field to engage the study object.

15. The method of claim 1, wherein engaging the at least one data object and the study object to initiate the data analysis function generates an output incorporated with the study object, the output including the graphical element output.

16. The method of claim 15, further comprising:
closing the engaged study object thereby generating a corresponding stored study object without the graphical element output; and
opening the stored study object to regenerate the engaged study object on the user interface including the graphical element output.

17. The method of claim 15, wherein the engaged study object incorporates a tool object element, a data object element, and a graphical element output, and
wherein said data object element and said graphical element output are absent from said stored study object.

18. The method of claim 1, further comprising:
enabling a data source panel providing a data object selection region to present a plurality of data objects each associated with a stored data set including said at least one data object, and prior to engaging the study object, enabling the at least one data object associated with the at least one stored data set.

19. The method of claim 18, wherein presenting the plurality of data objects includes, for each data object, providing at least one visual attribute corresponding to a property of the associated data set.

20. The method of claim 19, wherein providing at least one visual attribute includes indicating a data set count and a data type.

21. The method of claim 19, wherein providing at least one visual attribute includes presenting a movable icon substantially matching a data variables field icon of the study object, the movable icon being substantially movable into the data variables field icon to engage the study object.

22. The method of claim 19, wherein enabling the at least one data object further displays a window containing properties of the data set, including output of data analysis on the associated data set.

23. A computer-implemented method of process mapping on a graphical user interface of a computer display, said computer-implemented method comprising:
providing a computer display of a computing apparatus having a controller, the computer display configured to present a graphical user interface containing a plurality of graphical objects controllable by the controller;
in response to user prompt and selections, initiating a data analysis function to generate a graphical element output using at least one stored data set as input variables;
generating a stored study object corresponding to the graphical element output and identified with the data analysis function and the at least one stored data set, whereby the stored study object is controller engageable to regenerate the graphical element output; and
repeating said initiating a data analysis function in respect to each of one or more stored data sets to generate one or more stored study objects; and
positioning a plurality of said stored study objects in mutual graphical relation to generate a process map.

24. The method of claim 23, wherein the user interface includes a study object storage region, said method further comprising:
storing the stored study object in the study object storage region after said initiating a data analysis function; and
wherein said positioning the study objects includes retrieving the stored study object from the study object storage region and positioning the stored study object in a second region of the user interface.

25. The method of claim 23, wherein initiating the data analysis function generates said study object in engaged mode, including displaying a data object element associated with the at least one stored data set, a data analysis function object element identifying the data analysis function, and the graphical element output.

26. The method of claim 25, wherein each of said stored data sets are commonly identified to a project.

27. The method of claim 26, wherein a graphical object element is created upon generation of the process map, the graphical object element being engageable to regenerate the process map associated therewith.

28. The method of claim 25, wherein the study objects are mutually graphically associated by graphical segments connecting the stored study objects.

29. (canceled)

30. (canceled)

31. (canceled)

32. The method of claim 27, wherein the study objects are mutually graphically associated by being mutually presented on a common graphical underlay, and
wherein positioning the study objects further includes positioning the study objects on the user interface in mutual graphical association, whereby the study objects are mutually graphically associated by graphical segments connecting the stored study objects.

33. (canceled)

34. (canceled)

35. The method of claim 23, wherein initiating a data analysis function includes selecting, from the user interface, a tool object identifying the data analysis function to generate the study object on the user interface and a data object associated with the stored data set, and engaging the data object with the tool object to engage the study object and initiate the data analysis function, thereby generating an engaged study object with a graphical element output included therewith, the graphical element being selected from the group consisting of graphs, charts, tables, and combinations thereof.

36. A non-transitory computer-accessible storage medium storing program instructions computer-executable to implement one or more graphical user interfaces for presentation of a process map on a computer display;
the graphical user interface including a plurality of stored study objects, each stored study object identifying a data analysis function and engageable to display a graphical element output to initiation of the data analysis function with a prior selected stored data set as input variables; wherein a plurality of the stored study objects is positioned on the user interface in mutual graphical association, whereby a relative arrangement of the study objects presents a multi-study project process map.

37. The non-transitory computer accessible storage medium of claim 36, wherein the study objects are mutually graphically associated by graphical segments connecting the stored study objects.

38. The non-transitory computer accessible storage medium of claim 37, wherein the study objects are mutually graphically associated by graphical segments connecting the stored study objects, such that a string of stored study objects connected by graphical segments indicate a chronological project flow.

39. The non-transitory computer accessible storage medium of claim 37, wherein the graphical segments are line segments indicating logic direction.

40. The non-transitory computer accessible storage medium of claim 37, wherein the graphical segments include graphical object elements that are controller engageable to display additional graphical elements associated with the graphical object element.

41. The non-transitory computer accessible storage medium of claim 37, wherein the study objects are mutually graphically associated by being mutually presented on a common graphical underlay.

42. (canceled)

43. The non-transitory computer accessible storage medium of claim 37, wherein the graphical segments are serially connected critical question, study, and answer graphical objects.

44. A computing system, comprising:
one or more processors;
a display;
a memory coupled to the one or more processors, wherein the memory stores program instructions executable by the one or more processors to display a graphical user interface on the display, the graphical user interface including:
a plurality of stored study objects, each stored study object identifying a data analysis function and engageable to display a graphical element output to initiation of the data analysis function with a prior selected stored data set as input variables; and
wherein a plurality of the stored study objects is positioned on the user interface in mutual graphical association, whereby a relative arrangement of the study objects presents a multi-study project process map.

45. The computing system of claim 44, wherein the study objects are mutually graphically associated by graphical segments connecting the stored study objects.

46. (canceled)

47. (canceled)

48. (canceled)

49. (canceled)

50. The computer system of claim 44, wherein the study objects are mutually graphically associated by a common graphical underlay, and
wherein the graphical underlay includes graphical elements identified to stages of a project, each of the study objects being identified to said graphical elements.

51. (canceled)

52. (canceled)
